(19) United States
(12) Patent Application Publication
(10) Pub. No.: US 2004/0234114 A1
(43) Pub. Date: Nov. 25, 2004

(54) Device and method for reading information outputted from microarray of biologically related substances and method for correcting shading of the device

(75) Inventors: Takeaki Amakawa, Kawasaki-shi (JP); Teruta Ishimaru, Yokohama-shi (JP); Noboru Fujikura, Kawasaki-shi (JP); Kouji Shimizu, Yokohama-shi (JP); Chiaki Nagahama, Yokohama-shi (JP); Chiho Itou, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Mitsubishi Rayon Co., Ltd., Tokyo (JP)

(21) Appl. No.: 10/847,861

(22) Filed: May 19, 2004

(30) Foreign Application Priority Data
May 22, 2003 (JP) 2003-144840

(51) Int. Cl. G06K 9/00

(52) U.S. Cl. 382/128

(57) ABSTRACT

The present invention relates to a reading device (1) for reading the fluorescence emitted from a fluorescent material present in a microarray (A), which is characterized in that it comprises a transmission light source (2) for transmitting light rays through the microarray (A); an excitation light source (6) for exciting the fluorescent material; an imaging means (4) for imaging the light passing through the microarray and imaging the fluorescence emitted from the fluorescent material; and a detection means (5) for detecting the position and/or size of a specific division arranged on the microarray on the basis of the images of the light which transmits through the microarray.

### BACKGROUND OF THE INVENTION

The present invention relates to a device for reading excited fluorescent light rays emitted from a fluorescent material when it is irradiated with excitation light rays, the fluorescent material being incorporated into a microarray of biologically related substances, which comprises probes immobilized and put in order or arranged on the microarray, through a reaction with a specimen provided with such a fluorescent material associated with the same.

The present invention also relates to a method for correcting any shading of an incident-light type excited fluorescence-detection device for reading the quantity of excited fluorescence emitted from a fluorescent material associated with a specimen when irradiating the specimen with excitation light rays.

There have recently been drawn up and carried out various genome projects in respect of a wide variety of organisms and there have accordingly been elucidated rapidly, various kinds of genes including human genes and the base sequences thereof. The functions of each gene whose base sequence has been elucidated can be investigated according to various methods. As one of the prominent methods, there has been known one for analyzing gene expression which makes the most use of the information concerning the base sequences thus elucidated. This analysis method makes use of, for instance, a microarray in which several tens to several tens of thousands of biologically related substances such as different genetic peptides, proteins and/or antibodies as probes are immobilized on either of divisions each comprising a high molecular weight gel-like substance supported on, for instance, the surface or depressed or projected portions of a substrate, or the inner walls or hollow portions of capillaries. According to this method, the relation between the substances used as such probes and the expression of biological functions can be investigated, while making use of a variety of reactions specific to the probes. Such a method has been developed as a novel analytical method or a methodological one referred to as the DNA microarray technique (DNA chip technique), which permits the collective expression and analysis of a plurality of genes in order to synthetically and systematically analyze a large number of genes on the order of those present in an individual, which have been elucidated by the recent genome projects.

In a method for detecting a reaction product of a probe with a specimen, a fluorescence-labeled specimen is first reacted with a biologically related substance immobilized on a microarray as a probe. Then the quantity of fluorescence emitted from the fluorescence-labeled specimen can be determined or detected by a fluorescence-measuring device such as a fluorescence-laser scanner or a fluorescence microscope to thus detect a specific probe which forms a reaction product with the fluorescence-labeled specimen.

Moreover, in a conventional image reader used for detecting the quantity of fluorescent light, shading correction has been carried out as one of image-processing methods in order to correct the light quantity-distribution pattern of an illumination source and the sensitivity difference between elements present in a detector.

The usual method for correcting such shading of the device comprises the steps of setting a standard white plate at a reading position, reading the quantity of light from the white plate while the illumination source remains on and storing the result. Then any light ray is never incident upon the detector by turning off the illumination source, the data on the detector is read and stored.

Subsequently, a sample is set at the reading position and the quantity of light from the sample is read by the detector while the illumination source remains on. In this respect, if the elements within the detector are numbered serially, Sp is defined to be the data on the sample read by the number p (p-th) element, Lwp is defined to be the data on the standard white plate read by the same element while the illumination source remains on and Dp is likewise defined to be the data read by the same element when the source is turned off, the shading correction performed in this case can be expressed by the following equation:

Sp′=[(Sp−Dp)×m]/(Lwp−Dp)

In this equation, Sp′ corresponds to the data detected by the p-th element obtained after the shading correction and m represents a constant. Moreover, if the detector provides data concerning the exposure time, observed when the detector is a CCD element, each datum in the foregoing equation should be handled as one per unit time.

When the shading correction method explained above is applied to an incident-light type excited fluorescence-detection device 300 such as that shown in FIG. 18, each datum would be corrected while the illumination source-lighted up state and the illumination source-switched off state are substituted for the state irradiated with excitation light and the excitation light-shut-off state, respectively. Ideally, in this case, the excitation light comprises only light rays of a desired excitation wavelength obtained by passing light rays emitted from an excitation light source 303 through an excitation filter 304, the excitation light thus obtained is incident upon a reflecting plate disposed at the sample-setting position through a dichroic mirror 305 and an objective 307, the light rays reflected by the reflecting plate are cut off or filtered off through the dichroic mirror 305 or a filter 306 for absorption and they are thus never detected by a detector 310.

However, when the wavelength of the excitation light is in close proximity to that of the fluorescent light, it is quite difficult to strictly cut the light rays having wavelengths other than that of the excitation light off. Accordingly, in such cases, the use of a highly sensitive detector 310 would permit the detection of the distributed state of excitation light rays.

When the intensity of the fluorescence emitted from a specimen is low and a microarray is inaccurate in the arrangement of the arrays thereon, however, a problem arises such that it would be quite difficult to correctly recognize the correspondence between the detected fluorescence and the biologically related substance immobilized on the microarray as a probe and that it is also quite difficult to easily and accurately discriminate the very probe which forms a hybrid with the specimen.

In this connection, Japanese Un-Examined Patent Publication 2001-27607 discloses a method for reading microarrays which may solve the foregoing problems. In this method, a fluorescent material other than that for labeling a specimen is, in advance, incorporated into a biologically related substance to be immobilized on the microarray as a probe to thus detect the position of a spot by the detection of the fluorescence emitted when the fluorescent material incorporated into the probe is excited.

In this method, however, it is necessary to incorporate a fluorescent material other than that associated with the specimen into a biologically related substance which is immobilized on the microarray as a probe and a problem accordingly arises in that the fluorescent material associated with the biologically related substance and used for preliminarily detecting or determining the position of a specific probe may serve as a source of noise in the detection of the fluorescent material attached to the specimen which is, by nature, the subject to be detected. This method likewise suffers from a problem such that it is needed to assemble a novel optical system such as a filter for detecting the fluorescent material separately incorporated into the biologically related substance.

Furthermore, in a device such as a fluorescent laser scanner used for the detection of the quantity of fluorescence, a laser is used as an excitation light source for the excitation of a fluorescent material. For this reason, the wavelength range of the excitation light is quite narrow and accordingly, the wavelength range of the fluorescence can relatively easily be distinguished from the former. As a result, a higher S/N ratio would be ensured in the detection of the fluorescence. However, this method requires the use of a mechanism for scanning a laser beam and therefore, this method suffers from a problem in that the resulting device is relatively expensive and that the maintenance thereof is rather difficult or troublesome.

Contrary to this, a device such as a fluorescence microscope used for the detection of the quantity of fluorescence uses a white light source and accordingly, the excitation light is distinguished from the fluorescence through the use of an optical filter. For this reason, one can easily cope with, for instance, exchange of a fluorescent material for another one, by making alterations in, for instance, the combination of optical filters and accordingly, the maintenance of the resulting system is relatively easy. However, when the wavelength of the excitation light is in close proximity to that of the fluorescent light, it is quite difficult to completely distinguish the excited light rays from the fluorescence because of the characteristic properties of optical filters used and this in turn leads to the reduction of the S/N ratio and the narrowing of the dynamic range of the system.

Moreover, when the foregoing shading correction is performed in the image-reading device described above, the excited light rays are reflected not only by the reflecting plate, but also by a variety of parts or members arranged in the optical path such as a filter 304 for excitation, a dichroic mirror 305, a filter 306 for absorption and the lens surface of an objective 307 and the excited light distribution thus detected is constituted by all of these reflected light rays.

For this reason, the excited light distribution expressed in terms of Lwp appearing in the foregoing equation does not accurately correspond to that in fact incident upon the sample and any precise shading correction cannot be ensured at all.

### SUMMARY OF THE INVENTION

Accordingly, it is an object of the present invention to provide a device and a method for reading information on a microarray which permits the acquisition of accurate information concerning the position and/or size of a division to be detected having a biologically related substance immobilized thereon without incorporation of any additional material into the biologically related substance used as a probe even when the fluorescence intensity of a specimen is low and/or the arrays are arranged on a microarray in poor positional precision.

It is another object of the present invention to provide a method for reading information on a microarray, which can ensure a high S/N ratio and a wide dynamic range even when the wavelength of the excitation light is in close proximity to that of the fluorescent light emitted by a sample to be analyzed and which permits the determination of the fluorescence intensity in a high precision even when using an array capable of emitting only fluorescence having a low intensity.

It is a further object of the present invention to provide a shading correction method which permits the precise correction of any shading in the incident-light type excited fluorescence detection in which a sample is irradiated with excitation light rays and the fluorescence emitted from the same is detected and read from the light-reflecting direction.

According to an aspect of the present invention, the foregoing problems associated with the conventional technique can be eliminated by providing a device for detecting and reading fluorescent light rays emitted from a fluorescent material incorporated into a multiple divisions-containing microarray of a biologically related substance through a reaction with a specimen provided with such a fluorescent material associated with the same, the device being characterized in that it comprises a light source for emitting light rays transmitting through the microarray; a light source for emitting light rays used for the excitation of the fluorescent material present in a division; an imaging means for imaging light rays which are emitted from the transmission light source and which are incident upon and transmit through the microarray and for imaging fluorescent rays emitted from the fluorescent material excited by the irradiation with the light from the source for excitation; and a means for the detection of the position and/or size of a division arranged on the microarray on the basis of images of the light rays, which are converted into an image by the imaging means and transmit through the microarray.

According to a preferred embodiment, the portions of the microarray other than the division are so designed that they are opaque.

According to another preferred embodiment, the device further comprises a means for moving the division arranged on the microarray into the visual field of the imaging means on the basis of the position of the division arranged on the microarray.

Then the divisions of the microarray are reacted with a specimen associated with a fluorescent material to thus form a reaction product of the probe on the microarray and the specimen. Thereafter, the light rays emitted from the transmission light source are incident upon the microarray and the light rays which transmit through the microarray are imaged or converted into an image by the imaging means.

The detection means detects the position and/or size of a division on the microarray from the image of the transmitted light thus imaged. Preferably, the detection means detects the positions of the overall divisions present on the microarray based on the images of the transmitted light thus imaged. Then the microarray is moved in such a manner that the central position of the overall divisions on the microarray is in good agreement with the central position of the visual field of the imaging means. Thereafter, the light rays emitted from the transmission light source are again incident upon the microarray, the light rays which transmit through the divisions on the microarray are imaged by the imaging means and the detection means detects the positions and/or sizes of the divisions on the microarray from the images of the transmitted light thus imaged.

In addition, the microarray is then irradiated with excitation light rays emitted from the excitation light source to thus allow the fluorescent material to fluoresce. The fluorescence thus generated is converted into an image by the action of the imaging means and the image thus obtained is analyzed while taking into consideration the information concerning the position and/or size of the division previously detected.

This constitution or structure of the device would permit the easy recognition of the position and/or size of a specific division formed on the microarray and therefore, the fluorescence emitted by the desired fluorescent material can accurately be detected even when using a microarray on which divisions are arranged in poor positional precision and/or when only weak fluorescence is emitted from the microarray.

In a preferred embodiment, the device is so designed that it selects a part of the image of the light transmitting through the microarray and imaged by the imaging means and detects the fluorescence emitted from the selected part.

The device according to the present invention and having the foregoing constitution picks up the imaginal information concerning the partial spot as the image of the division detected by imaging the transmitted light and conducts analysis on the basis of the imaginal information. This constitution would permit the elimination of any influence, on the desired analysis, of the fluorescence emitted from origins other than the fluorescent material on the microarray to be detected such as auto-fluorescence emitted from the materials for the parts other than the microarray.

According to a further preferred embodiment of the device of the present invention, the detection means further comprises a correction means for correcting or compensating any difference between the optical systems used for imaging the transmitted light outputted from the microarray and for imaging the fluorescence emitted from the fluorescent material, respectively.

In the device of the present invention having the foregoing structure, the optical system used for imaging the transmitted light outputted from the microarray differs from that used for imaging the fluorescence emitted from the fluorescent material and the difference in the optical system becomes a cause of a discrepancy between these two kinds of images obtained. However, the device of the present invention permits the precise detection of the desired division without any significant error.

Further, the imaging means may be composed of a CCD camera.

In addition, a single light source may be used as both the transmission and excitation light sources.

Moreover, the transmission or excitation light source may be so designed that it comprises a light-emitting means and an optical fiber bundle for guiding the light rays emitted from the light-emitting means.

In the device of the present invention having the foregoing structure, the transmission or excitation light source may be arranged at any position and this structure would permit the inhibition of any irradiation of the microarray with the thermic rays emitted from the light source by the use of the optical fiber.

Furthermore, the transmission or excitation light source may likewise be composed of an LED light source.

The device of the present invention having the foregoing constitution would thus permit the extension of the service life of the transmission or excitation light source.

Moreover, the arrays in the microarray may be arranged in a lattice so that the divisions thereof may form a plurality of blocks.

The device of the present invention having such a constitution makes easy the determination of the visual field suitable for imaging the microarray as compared with the case wherein the microarray having divisions arranged thereon without dividing them into blocks is imaged over a plurality of times.

Further, the device may likewise be so designed that it further comprises a means for moving the position at which the microarray is imaged and a means for indexing the position of a block arranged on the microarray and that the imaging means images the microarray for each block.

According to the device of the invention having such a structure, the division C can be imaged at a high resolution as compared with the case in which all of the divisions C arranged on a microarray A are imaged at a time.

According to another aspect of the present invention, there is provided a method for reading information from a microarray of a biologically related substance and the method comprises the steps of preparing a multiple divisions-containing microarray of a biologically related substance, which is reacted with a specimen provided with a fluorescent material associated with the same; irradiating the microarray with light rays and imaging the transmitted light which transmits through the microarray; detecting the position and/or size of a division on the basis of the transmitted light which has been imaged in the transmitted light-imaging step; irradiating the microarray with excitation light rays to thus excite the fluorescent material present in the division of the microarray and imaging the fluorescence emitted from the fluorescent material; and reading the fluorescence imaged in the fluorescence-imaging step on the basis of the position and/or size of the division detected based on the transmitted light.

Alternatively, the present invention likewise provide a method for reading information from a microarray of a biologically related substance and the method comprises the steps of preparing a multiple divisions-containing microarray of a biologically related substance, which is reacted with a specimen provided with a fluorescent material associated with the same; irradiating the microarray with light rays and imaging the transmitted light which transmits through the microarray; moving a division arranged on the microarray to an appropriate position within the visual field, to be imaged, of the imaging means on the basis of the transmitted light imaged in the transmitted light-imaging step; again irradiating the microarray with light rays and imaging the transmitted light which transmits through the microarray; detecting the position and/or size of the division; irradiating the microarray with excitation light rays to thus excite the fluorescent material present in the division of the microarray and imaging the fluorescence emitted from the fluorescent material; and reading the fluorescence imaged in the fluorescence-imaging step on the basis of the position and/or size of the division detected based on the transmitted light.

The method for reading information from a microarray according to the present invention further comprises an additional step of masking the image obtained by imaging the fluorescence emitted from the fluorescent material, on the basis of the position and/or size of the division detected in the detection step.

Moreover, the arrays on the microarray may be arranged in a lattice so that the divisions thereof may form a plurality of blocks and in the moving step, the microarray may be moved in such a manner that the blocks are moved into the visual field to be imaged one at a time.

Furthermore, the inventors of this invention have conducted various studies to develop a method for determining the intensity of fluorescence while ensuring a high S/N ratio and a wide dynamic range even when the wavelength of the excitation light is in close proximity to that of the fluorescent light and as a result, the inventors have found that if the image, which is obtained by imaging the light detected when the measuring system free of any microarray is irradiated with excitation light rays, is defined to be the background, the intensity of fluorescence can highly precisely be determined while ensuring a high S/N ratio and a wide dynamic range even when using an array having a low fluorescence intensity.

More specifically, the present invention relates to a microarray-reading method for reading the fluorescence emitted by a fluorescent material incorporated into the microarray through a reaction of a division of the microarray on which a prove is immobilized with a specimen provided with such a fluorescent material associated with the same and the method comprises the following steps: a first step of preparing the microarray at a desired sample-supporting position; a second step comprising irradiating the microarray with excitation light rays to thus excite the fluorescent material present in the division of the microarray and imaging the fluorescence emitted from the fluorescent material; a third step of imaging the light obtained when irradiating with excitation light rays, while any microarray is not present at the sample-supporting position; and a step of subtracting the image obtained in the third step as the background from the image obtained in the second step.

Alternatively, the present invention also relates to a microarray-reading method for reading the fluorescence emitted by a fluorescent material incorporated into the microarray through a reaction of a division of the microarray on which a prove is immobilized with a specimen provided with such a fluorescent material associated with the same and the method comprises the following steps: a first step of preparing the microarray at a desired sample-supporting position; a second step comprising irradiating the microarray with excitation light rays to thus excite the fluorescent material present in the division of the microarray and imaging the fluorescence emitted from the fluorescent material over several times; a third step of imaging the light obtained when irradiating with excitation light rays, while any microarray is not present at the sample-supporting position; and a step comprising subtracting the image obtained in the third step as the background from each of the plurality of images obtained in the second step and adding the plurality of images obtained in the subtraction step.

The present invention further relates to a microarray-reading method for reading the fluorescence emitted by a fluorescent material incorporated into the microarray through a reaction of a division of the microarray on which a prove is immobilized with a specimen provided with such a fluorescent material associated with the same and the method comprises the following steps: a first step of preparing the microarray at a desired sample-supporting position; a second step comprising irradiating the microarray with excitation light rays to thus excite the fluorescent material present in the division of the microarray and imaging the fluorescence emitted from the fluorescent material after the elapse of a plurality of different exposure times; a third step of imaging the light obtained when irradiating with excitation light rays, while any microarray is not present at the sample-supporting position; and a step comprising subtracting the image obtained in the third step as the background from each of the plurality of images obtained in the second step, normalizing the plurality of images obtained in the subtraction step with values proportional to 1/(exposure time) and extracting data from the resulting plurality of images.

Furthermore, the inventors of this invention likewise conducted intensive studies to solve the problems associated with the foregoing shading correction, have found that if the data, which are obtained by imaging the light detected when the measuring system free of any microarray is irradiated with excitation light rays, are defined to be the background data of the device in itself, the shading correction can highly precisely be conducted and have thus completed the present invention.

More specifically, the present invention relates to a shading-correction method employed in the incident-light type excited fluorescence detection in which a sample is irradiated with excitation light rays and the fluorescence emitted from the same is detected and read from the light-reflecting direction and the method comprises the following steps: a first step comprising irradiating with excitation light rays, while any sample is not present and storing the datum detected by a detector as the background datum for the device in itself; a second step comprising irradiating with excitation light rays, while setting a reference reflecting plate having a predetermined reflectivity at a sample-setting position, subtracting the background datum for the device in itself from the datum detected by the detector and storing the datum obtained in the subtraction step as one for the shading-correction; and a third step comprising irradiating with excitation light rays, while a sample is set at the sample-setting position, subtracting the background datum for the device in itself from the datum detected by the detector and carrying out desired shading-correction on the basis of the foregoing datum for the shading-correction.

According to the microarray-reading device of the present invention, the precise information concerning the position and/or size of a division on a microarray to be detected, on which a probe is immobilized, can be obtained even when a specimen provides only a low fluorescence intensity and the arrays on a microarray are arranged in a poor positional precision, without incorporation of any additional substance into the probe.

According to the microarray-reading method of the present invention, the precise information concerning a division on a microarray to be detected, on which a probe is immobilized, can be obtained in a high sensitivity even in a microarray which makes use of a specimen having a low fluorescence intensity.

In addition, the shading-correction method according to the present invention permits the distinct separation of noise light rays due to the stray light of incident-light type excited fluorescence detector by nature from the distribution of the excitation light rays applied to a sample and the measurement of the same in such an excited fluorescence detector and this in turn permits the implementation of high precision shading-correction.

### BRIEF DESCRIPTION OF THE DRAWINGS

The present invention will hereunder be described in more detail with reference to the accompanying drawings, wherein

FIG. 1 is a schematic block diagram showing a microarray-reading device according to a first embodiment of the present invention.

FIGS. 2A to 2C are plan views showing three different microarrays, respectively, used in the microarray-reading device according to the first embodiment of the present invention.

FIG. 3 is a diagram showing an example of spots of light rays which pass through a microarray and which are imaged by a CCD camera.

FIG. 4 is a diagram showing an exemplary result obtained after reducing the diameters of the spots of the transmitted light shown in FIG. 3.

FIG. 5 is a diagram showing an example illustrating spots of fluorescent light rays which are outputted from a microarray and which are imaged by a CCD camera.

FIG. 6 is a diagram showing the result obtained when the contours of the spots of the transmitted light, which have reduced diameters and which are shown in FIG. 4, are superimposed on the spots of the fluorescent light rays shown in FIG. 5.

FIG. 7 is a graph showing the relation between the values of every fluorescence spots read by CCD and the concentration of the fluorescent material immobilized on the corresponding spots.

FIG. 8 is a schematic block diagram showing a microarray-reading device according to a second embodiment of the present invention.

FIG. 9 is a diagram showing an example of a case wherein spots of the light passing through a microarray and imaged by a CCD camera deviate from the visual field of the CCD camera.

FIG. 10 is a schematic block diagram showing an example of a microarray-reading device which makes use of a fluorescence microscope.

FIG. 11 is a photograph showing an example of an image used for correction, which is imaged by a CCD camera.

FIG. 12 is a photograph showing an example of a fluorescence image obtained using a CCD camera.

FIG. 13 is a graph showing the line profile observed along the line D on the image shown in FIG. 12.

FIG. 14 is a photograph showing the stray light and the excitation light speckle-correction fluorescence image obtained by applying the technique of the present invention to the images shown in FIGS. 11 and 12.

FIG. 15 is a graph showing the line profile observed along the line D on the image shown in FIG. 14.

FIG. 16 is a photograph showing an example of the 5-fold superimposed stray light and excitation light speckle-correction fluorescence image obtained after the application of the technique of the present invention.

FIG. 17 is a graph showing the line profile observed along the line D on the image shown in FIG. 16.

FIG. 18 is a schematic block diagram showing an example of an incident-light type excited fluorescence detector which makes use of an incident-light fluorescence microscope.

### DESCRIPTION OF THE PREFERRED EMBODIMENTS

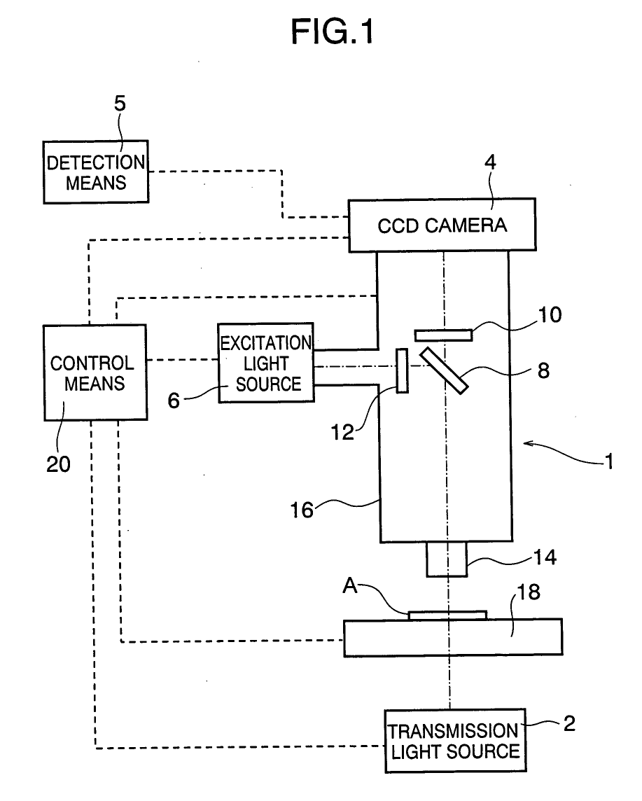

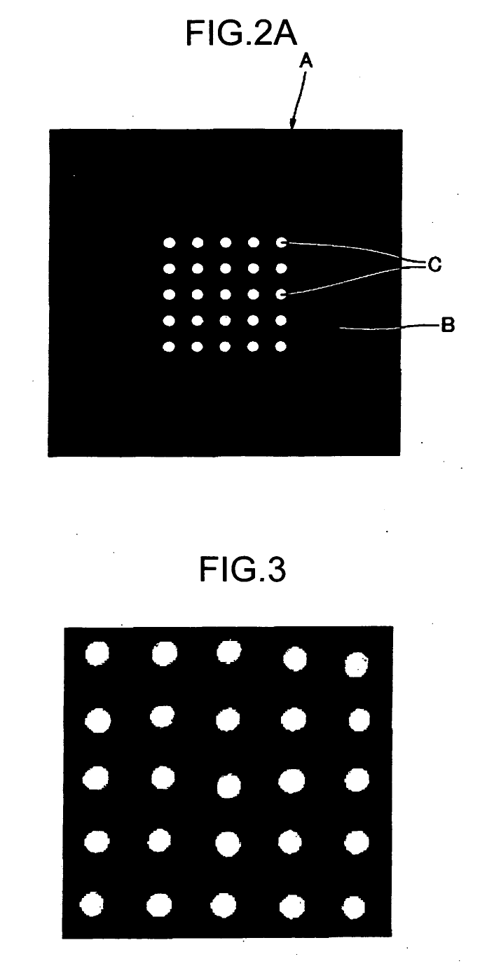

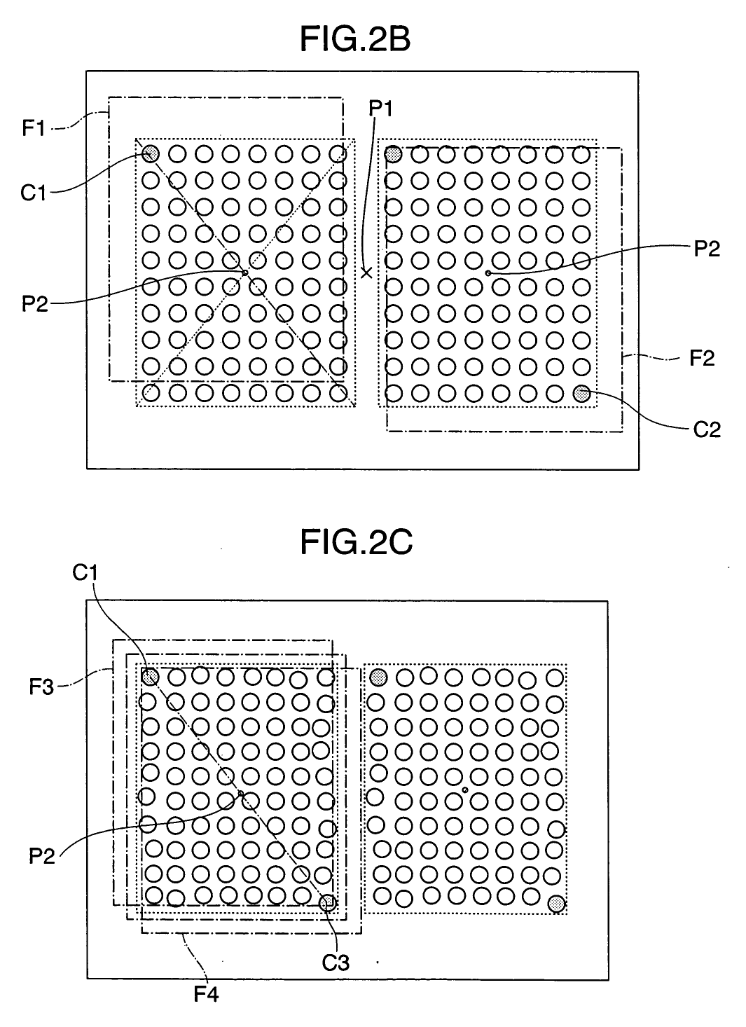

Then the present invention will be described in more detail with reference to the accompanying drawings. FIG. 1 is a schematic block diagram showing a microarray-reading device according to a first embodiment of the present invention. In addition, FIGS. 2A and 2B are plan views of the microarray A used in the microarray-reading device according to this embodiment. As shown in FIG. 1, the microarray-reading device 1 according to the first embodiment of the present invention comprises a light source 2 (transmission light source) for emitting light rays which are incident upon the microarray A and transmit through the same and a light source 6 (excitation light source) for emitting light rays which are applied to the microarray A for the excitation of a fluorescent material present therein. Moreover, the microarray-reading device 1 further comprises a CCD camera 4 as an imaging means for imaging transmitted light rays which transmit through the microarray and for imaging fluorescent rays emitted from the fluorescent material attached to a specimen present on the microarray A and a detection means 5 for analyzing the specimen on the basis of the images which are converted into an image or imaged by the imaging means.

Moreover, the microarray-reading device 1 likewise comprises a microscope 16 which is equipped with an optical system constituted by a dichroic mirror 8 for transmitting or reflecting desired light rays, a filter 10 for absorption, a filter 12 for excitation and an objective 14 for the microarray A. Further, the microarray-reading device 1 comprises an XY stage 18 for moving the microarray A to a desired position on a horizontal plane, a focusing stage (not shown) for moving the XY stage 18 or the objective 14 vertically in order to focus the image of the microarray photographed or imaged by the CCD camera 4 and a control device 20 for controlling, for instance, the light source 2 for transmitting light rays, the CCD camera 4, the excitation light source 6 and the XY stage 18.

The transmission light source 2 is positioned below the XY stage 18 so that the optical axis of the light emitted by the light source is in good conformity with that of the microscope 16. As the transmission light source 2 usable herein, there may be listed, for instance, a halogen lamp or an LED array-light source comprising a plurality of light emitting devices put in order. In this embodiment, an LED array-light source or a halogen lamp is used as the transmission light source 2.

Moreover, the transmission light source 2 is not necessarily disposed below the XY stage 18 and accordingly, it may have such a structure that the transmission light source disposed at a position other than that below the XY stage 18 can emit light in the direction in conformity with the optical axis of the microscope 16 through the use of appropriate parts such as a lens and/or a mirror. Alternatively, it is also possible to direct the light emitted from a light source to a desired position using an optical fiber bundle. When the light is thus guided using an optical fiber bundle, almost all of the thermic rays included in the light rays from the source can be eliminated by the optical fiber.

Further, if the output end of each optical fiber is adjusted to the position on a microarray A at which each division C is positioned, the light rays from the source can efficiently be incident upon each division C. In addition, the use of an LED as a light source would ensure a stable quantity of light rays and permit the considerable extension of the service life of the light source.

In addition, the excitation light source 6 is so arranged that it can emit light rays into the body tube of the microscope 16 through the side of the tube. It is herein preferred to select a light source containing a large quantity of components having wavelengths capable of exciting the fluorescent material present on the microarray A, as the excitation light source 6. In this embodiment, a high pressure mercury lamp is used as the excitation light source 6.

The excitation filter 12 is so designed that it can pass only the component having wavelengths capable of exciting the fluorescent material present on the microarray A among the light rays emitted from the excitation light source 6 and that it can cut off all of the other components of the light rays emitted from the source. On the other hand, the absorption filter 10 is so designed that it can pass only the light rays having a wavelength identical to that of the fluorescence outputted from the microarray A, but it inhibits the transmission of any component of light having a wavelength capable of exciting the fluorescent material. The dichroic mirror 8 is so designed and arranged that it can direct, to the microarray A, the light rays which have passed through the excitation filter 12 and which have wavelengths capable of exciting the fluorescent material.

This dichroic mirror 8 is likewise so designed to pass light rays having a wavelength identical to that of the fluorescence emitted from the fluorescent material present on the microarray A. In this embodiment, Cy3 is used as such a fluorescent material; a band path filter having a central wavelength of 610 nm and a half-width of 75 nm is used as the absorption filter 10; a band path filter having a central wavelength of 545 nm and a half-width of 30 nm is used as the excitation filter 12 and a mirror which reflect light rays having a wavelength of not more than about 570 nm and transmits light rays having a wavelength of not less than 570 nm is used as the dichroic mirror 8. In this respect, the dichroic mirror 8, the absorption filter 10 and the excitation filter 12 are preferably selected and constructed while taking into consideration the wavelength of the excitation light rays used for the excitation of the fluorescent material and the wavelength of the fluorescence emitted from the fluorescent material and when a plurality of fluorescent materials are used, the foregoing optical parts are designed such that each of them can easily be changed to another one in the microscope 16.

The CCD camera 4 is attached to the end of the body tube of the microscope 16 opposite to the objective 14 in such a manner that the optical axis of the former is completely consistent with that of the microscope 16. The CCD camera 4 herein used is preferably one provided with a function of cooling the camera (cooling CCD camera) so that it can image any weak fluorescence emitted from the microarray A while maintaining the noise to a low level. This embodiment comprises effective picture elements equal to 1392×1040 and is provided with a CCD camera having a cooling function, which is used in the condition cooled to −30° C. Moreover, the microscope 16 used in this embodiment is an incident-light type fluorescence microscope in which an objective having a magnification of ×2 is used and a lens having a magnification of ×0.5 is inserted into the same in front of the CCD camera or an optical system having a magnification of ×1.

The detection means 5 is designed in such a manner that it can conduct a variety of image-processing on the basis of the image data obtained by the CCD camera 4 to thus detect the fluorescence emitted from the microarray A. The detection means 5 may, for instance, comprise an interface for inputting the image data outputted from the CCD camera 4, a personal computer and a computer program for operating the computer.

In addition, the detection means 5 is equipped with a correction means 5a for correcting any deviation of the position of each image generated due to, for instance, the aberration of an optical system used; a masking means 5b for suppressing unnecessary portions of images; and an indexing means 5c for indexing a specific imaging position on the microarray A.

The XY stage 18 is so designed that it can move the microarray A on a horizontal plane whereby the CCD camera 4 can image every portions on the microarray A. A focusing stage (not shown) is designed such that it can vertically move the XY stage 18 or the objective 14 to thus focus the image of the microarray A photographed by the CCD camera 4. Moreover, the control device 20 serves to control, for instance, the imaging by the CCD camera 4; the movement of the XY stage 18; the on/off switching of the transmission light source 2 and the excitation light source 6; and the movement of the focusing stage. Alternatively, when using a light source of a type unfavorable for the applications, wherein the on/off operations are frequently repeated, as the transmission light source 2 or the excitation light source 6, a shutter (not shown) is positioned in front of the transmission light source 2 or the excitation light source 6 for cutting off any light and the opening and shutting operations of the shutter are controlled by the control device 20. The control device 20 is constituted by, for instance, actuators for operating every devices and a personal computer for sending signals to the actuators. In this respect, the personal computer used herein may also be used as one used in the detection means 5. Further, the control device 20 is provided with a means 20a for moving the XY stage 18 so that an intended portion on the microarray A can be imaged by the CCD camera 4.

Then the microarray A used in the microarray-reading device according to the first embodiment of the present invention will hereunder be explained in detail with reference to FIGS. 2A and 2B. The microarray A as shown in FIG. 2A is one in which a plurality of divisions C are arranged in a regular manner and each division C is constituted by a through hole. Such a microarray is, for instance, prepared according to the method disclosed in WO 00/53736; Japanese Un-Examined Patent Publication (hereunder referred to as “J.P. KOKAI”) 2000-60554; and J.P. KOKAI 2000-78998. Moreover, in the microarray A as shown in FIG. 2B, there are arranged two blocks each comprising 8×10 divisions which are arranged in a lattice.

In each division, a biologically related substance, which may serves as a probe, is immobilized on the inner wall of the division directly or through a gel.

The substrate portion B of the microarray A other than the divisions C is not particularly limited, in its construction, to any specific one insofar as the light transmittance thereof differs from that of the divisions C. Moreover, it is sufficient that the substrate portion B and the divisions C differ in their light transmittances and either of them may be transparent.

Preferably, the substrate portion B is constituted by an opaque material. The term “opaque” herein used means that a substance hardly transmits light through the same as compared with that used for forming the divisions C present on the microarray A and does not necessarily means that the light transmittance of such a material is 0%.

FIGS. 2A and 2B illustrate the division C as a hollow circular one by way of example, but the external shapes thereof are not restricted to circular ones at all. The structure of the division C has an internal diameter of 170 μm and an outer diameter of 220 μm.

Further, FIGS. 2A and 2B likewise illustrate, by way of example, a microarray in which the thicker portions of the divisions C and the substrate portion including the same made from a resin are constituted by materials whose light transmittance is not more than 1%. The thicker portion of the division C is formed from a Polymethylmethacrylate(PA) resin or a polycarbonate(PC) resin containing carbon black in an amount of 2%. These divisions C are horizontally arranged 5 by 5 at equal intervals or pitches of 420 μm and the circumference thereof is surrounded by a polyurethane resin containing carbon black 2.5%.

Then the operation of the microarray-reading device 1 according to the first embodiment of the present invention will be described below. In this respect, an experiment for inspecting the microarray-reading device 1 according to this embodiment for the detection accuracy will first be explained prior to the explanation of the technique for the detection of the fluorescence practically emitted from a specimen. In this inspection experiment, a fluorescent material is directly immobilized on a gel-like substance heldin each division C of the microarray A in a predetermined concentration and then the fluorescence emitted from the fluorescent material is detected.

First, a fluorescent material is immobilized on the gel-like substance held in every division C of the microarray A in different concentrations. In this inspection experiment, Cy3 was used as such a fluorescent material. The following Table 1 shows concentrations of the fluorescent material immobilized on different divisions C:

TABLE 1

| | Coord. of division | | Inner | Conc. Of fluor. |
|---|---|---|---|---|
| | center (μm) | | diameter of | Material |
| Divission No. | X | Y | division (μm) | [nmol/ml] |
| 1 | 0 | 0 | 170 | 1 |
| 2 | 420 | 0 | 170 | 0.5 |
| 3 | 840 | 0 | 170 | 0.1 |
| 4 | 1260 | 0 | 170 | 0.05 |
| 5 | 1680 | 0 | 170 | 0.02 |
| 6 | 0 | 420 | 170 | 0 |
| 7 | 420 | 420 | 170 | 0 |
| 8 | 840 | 420 | 170 | 0 |
| 9 | 1260 | 420 | 170 | 0 |
| 10 | 1680 | 420 | 170 | 0 |
| 11 | 0 | 840 | 170 | 0 |
| 12 | 420 | 840 | 170 | 0.0005 |
| 13 | 840 | 840 | 170 | 0.001 |
| 14 | 1260 | 840 | 170 | 0.005 |
| 15 | 1680 | 840 | 170 | 0.01 |
| 16 | 0 | 1260 | 170 | 0 |
| 17 | 420 | 1260 | 170 | 0 |
| 18 | 840 | 1260 | 170 | 0 |
| 19 | 1260 | 1260 | 170 | 0 |
| 20 | 1680 | 1260 | 170 | 0 |
| 21 | 0 | 1680 | 170 | 1 |
| 22 | 420 | 1680 | 170 | 0.5 |
| 23 | 840 | 1680 | 170 | 0.1 |
| 24 | 1260 | 1680 | 170 | 0.05 |
| 25 | 1680 | 1680 | 170 | 0.02 |

As will be seen from Table 1, numbers of 1 to 25 are assigned to these divisions C. More specifically, numbers of 1 to 5 are assigned to the divisions in the first row from the left end; the number 6 is assigned to the division existing at the left end of the second row and so forth on, and the number 25 is assigned to the division existing at the right end of the fifth row. The central coordinates of each division C and the concentration of the fluorescent material immobilized thereon are listed in Table 1. In addition, the central coordinates and the inner diameter of each division C are design values of the microarray A.

The microarray A thus constructed is irradiated with light rays using a projector followed by the determination of the position and diameter of the spot formed by the light passing through each division on the microarray A and the results thus obtained are listed in the following Table 2. Each value listed in Table 2 is the average of five measurements.

TABLE 2

| | Central Coord. of Spot (μm) | | Diameter of Spot |
|---|---|---|---|
| Spot No. | X | Y | (μm) |
| 1 | 0 | 0 | 170 |
| 2 | 430 | −2 | 175 |
| 3 | 848 | −15 | 164 |
| 4 | 1276 | 33 | 167 |
| 5 | 1675 | 71 | 174 |
| 6 | 12 | 450 | 175 |
| 7 | 425 | 418 | 164 |
| 8 | 849 | 441 | 164 |
| 9 | 1273 | 437 | 171 |
| 10 | 1702 | 442 | 158 |
| 11 | 2 | 836 | 170 |
| 12 | 433 | 831 | 160 |
| 13 | 860 | 889 | 167 |
| 14 | 1267 | 851 | 177 |
| 15 | 1692 | 843 | 167 |
| 16 | 13 | 1257 | 162 |
| 17 | 414 | 1252 | 158 |
| 18 | 859 | 1272 | 171 |
| 19 | 1257 | 1259 | 160 |
| 20 | 1695 | 1260 | 166 |
| 21 | −13 | 1673 | 158 |
| 22 | 421 | 1676 | 168 |
| 23 | 839 | 1677 | 165 |
| 24 | 1281 | 1685 | 170 |
| 25 | 1681 | 1691 | 156 |

Then this microarray A is mounted on the XY stage 18 of the microarray-reading device 1 according to the first embodiment of the present invention, the light rays emitted from the transmission light source 2 are allowed to transmit through the microarray A and the transmitted light rays are imaged by the CCD camera 4. FIG. 3 shows an example of the spot images observed for the transmitted light rays which are imaged by the camera. The picture elements constituting these spot images are divided into two groups by a predetermined threshold value and thus the portion brighter than the threshold value is recognized as the spot, while the other portions darker than the threshold value are recognized to be the portion other than the spot. Thereafter, the diameter of the spot image shown in FIG. 3 is contracted by the detection means 5. In this case, the diameter of each spot is contracted by about 70 μm. In this image-processing, there was used Image-Pro PLUS (registered trade mark) (an imaging software available from MEDIA CYBERNETICS). More specifically, the diameter of each spot was contracted by about 70 μm using 11×11 Circle option in the Morphological Erode as a filter function among the Process Menu of this software.

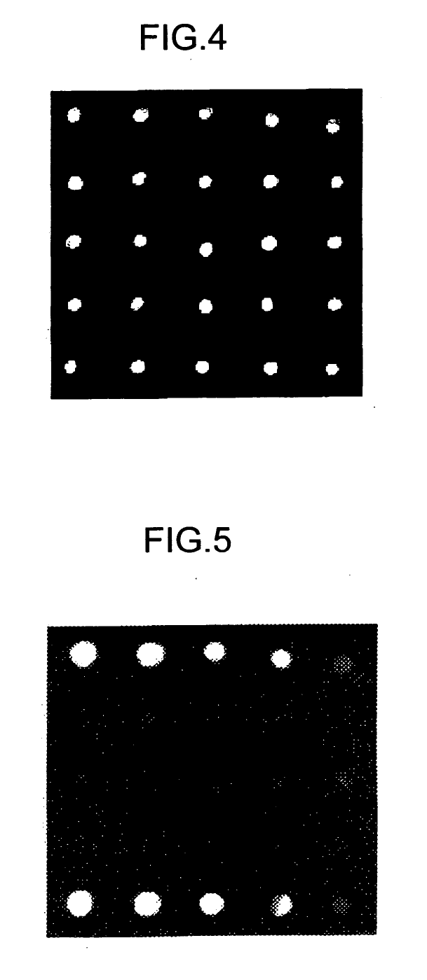

FIG. 4 shows an exemplary result obtained when each spot is image-processed by the detection means 5 to thus contract the diameter thereof. However, the image-processing may be conducted using any appropriate software and any appropriate image-processing method. For instance, the diameter of each spot is reduced by a constant amount in this embodiment, but the diameter of each spot may be reduced to a constant rate or it is also possible to define the spot portion as a region encircled by a circle with its center at the center of each spot and with a constant radius.

The positions and sizes of the spots shown in FIG. 4 were determined. The exemplary results thus obtained are listed in the following Table 3.

TABLE 3

| | Central Coord. of Spot (μm) | | Diameter of Spot |
|---|---|---|---|
| Spot No. | X | Y | (μm) |
| 1 | 0 | 0 | 98 |
| 2 | 432 | 2 | 103 |
| 3 | 848 | −8 | 93 |
| 4 | 1276 | 43 | 94 |
| 5 | 1675 | 85 | 101 |
| 6 | 9 | 448 | 104 |
| 7 | 420 | 420 | 92 |
| 8 | 845 | 446 | 93 |
| 9 | 1269 | 446 | 97 |
| 10 | 1697 | 454 | 86 |
| 11 | −2 | 833 | 100 |
| 12 | 427 | 833 | 90 |
| 13 | 852 | 894 | 97 |
| 14 | 1259 | 859 | 106 |
| 15 | 1685 | 855 | 93 |
| 16 | 5 | 1254 | 92 |
| 17 | 405 | 1252 | 89 |
| 18 | 849 | 1276 | 100 |
| 19 | 1246 | 1266 | 89 |
| 20 | 1684 | 1271 | 94 |
| 21 | −24 | 1669 | 90 |
| 22 | 408 | 1675 | 98 |
| 23 | 825 | 1679 | 95 |
| 24 | 1268 | 1692 | 100 |
| 25 | 1666 | 1701 | 86 |

When comparing the data listed in Table 2 with those listed in Table 3, it is found that the central coordinates of each spot are in good agreement with one another and that the spot diameter listed in Table 3 is smaller than that listed in Table 2 by about 70 μm. Accordingly, the measurement of the fluorescence observed at each spot on the basis of the position and size of the spot thus determined and listed in Table 3 would permit the determination of the fluorescence only at the central region of each division C on the microarray A while eliminating the fluorescence at the circumference of the division.

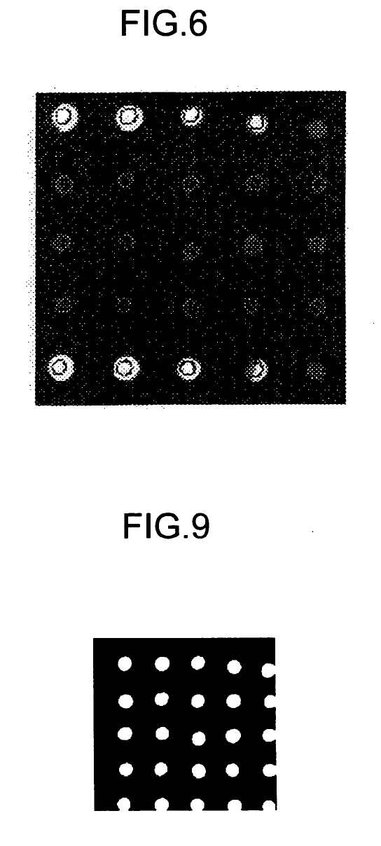

Subsequently, the microarray A mounted on the XY stage 18 of the microarray-reading device 1 is irradiated with the excitation light rays emitted from the excitation light source 6 and then the fluorescence emitted from the fluorescent material immobilized on a gel-like substance held in each division C arranged on the microarray A is imaged by the CCD camera 4. FIG. 5 shows an example of the image obtained by the CCD camera 4. In addition, FIG. 6 is a diagram showing the result obtained when the contours of the spots shown in FIG. 4 are superimposed on the images shown in FIG. 5.

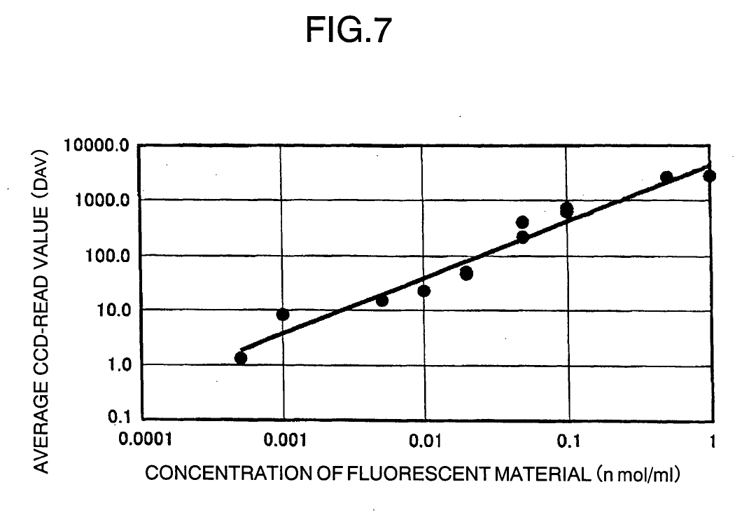

The average CCD-read value: D_{AV} obtained by averaging CCD-read values representing the brightness of the picture elements among the contours shown in FIG. 6 can be calculated by the detection means 5. FIG. 7 is a graph showing the relation between the average CCD-read value: D_{AV} observed for each spot and thus determined and the concentration of the fluorescent material immobilized on the corresponding spot. In this connection, however, each average CCD-read value: D_{AV} plotted as ordinate is a value obtained by subtracting, from the average CCD-read value for each spot, the value obtained by averaging CCD-read values for all of the spots free of any immobilized fluorescent material or at the fluorescent material concentration of 0 [nmol/ml]. In this respect, the average CCD-read value: D_{AV} plotted as ordinate and the fluorescent material concentration plotted as abscissa are expressed on log scales, respectively.

As shown in FIG. 7, there is observed an almost linear relation between the fluorescent material concentration and the average CCD-read value: D_{AV} plotted on the full-logarithmic graph. Therefore, the concentration of the fluorescent material immobilized on the gel-like substance held in each division C can be obtained from the average CCD-read value: D_{AV}.

Then the measurement of a specimen using the microarray-reading device 1 according to the first embodiment of the present invention will hereunder be described in detail. The actual measurement comprises the steps of preparing a microarray A on which a specimen labeled with a fluorescent material is applied and reading the fluorescence emitted by the material. The procedures for reading the fluorescence emitted from the microarray A are the same as those described above in connection with the inspection experiment and therefore, the details thereof are herein omitted.

The microarray-reading device according to a second embodiment of the present invention will now be described in detail below. The construction of the microarray-reading device according to this embodiment is identical to that of the microarray-reading device according to the first embodiment and accordingly, the details thereof are likewise omitted.

Then the operations of the microarray-reading device according to the second embodiment of the present invention will be described below. First of all, a microarray A comprising a probe in each division C is prepared. On the other hand, a specimen to be analyzed is labeled with a fluorescent material and the resulting specimen is applied on the foregoing microarray A. When a certain specimen interacts with a probe having a desired structure, the probe reacts with the specimen to thus give a reaction product. Accordingly, the fluorescent material associated with the specimen is immobilized within the division C on the microarray A. Thus, the fluorescent material can be present only in the division C which immobilizes the probe having such a structure capable of forming a hybrid with the specimen to be analyzed.

A plate (not shown) uniformly diffusing light rays (diffusion plate) is mounted on the XY stage 18 of the microarray-reading device 1 prior to the initiation of the reading of the microarray A. Then the diffusion plate is irradiated with the light rays emitted from the excitation light source 6 and the light rays reflected from the diffusion plate are imaged by the CCD camera 4. The information concerning the diffused image thus imaged is stored in the detection means 5 in order to use the same in the correction of spots representing quantities of light rays. The images to be taken at this stage are ones obtained by imaging the spots which are observed upon irradiation with excitation light rays and they are in general imaged while they are out of focus with respect to the diffusion plate. Alternatively, it may likewise possible to irradiate the XY stage 18 with the light rays emitted from the excitation light source 6 without using any diffusion plate or in the condition wherein there is nothing on the XY stage 18 or there is nothing on the sample-supporting surface of the stage and to image the light from the surface of the XY stage using the CCD camera 4.

Then the microarray A is fitted to the XY stage 18. In this respect, when the position on the XY stage 18 at which the microarray A is fitted to the stage differs from that on the same stage at which the measurement of the microarray A is conducted, the XY stage 18 should be shifted to the position thereof for the measurement.

Thereafter, the microarray A is irradiated with the light rays emitted from the transmission light source 2. The light rays emitted from the transmission light source 2 and passing through the microarray A are imaged by the CCD camera 4 through the objective 14. Regarding the image taken at this stage, the divisions C on the microarray A do not completely fall within the visual field of the CCD camera 4 due to a variety of factors such as the dimensional accuracy of the microarray A, the accuracy in the arrangement of divisions C on the microarray A, the positional accuracy observed when the microarray A is mounted on the XY stage 18 and the accuracy in the movement of the XY stage 18, as will be seen from, for instance, FIG. 9. In this connection, regarding the visual field of the CCD camera 4 as shown in FIG. 9, the scope of the images to be taken in the visual field is controlled in consideration of the arrangement of the divisions C on the microarray A used in order to make the moving speed of the CCD camera 4 as high as possible.

Subsequently, the overall position of the divisions C on the microarray A is calculated in the detection means 5 on the basis of the information concerning the positions and number of the divisions C appearing in the image taken by the CCD camera 4.The moving means 20a of the control device 20 moves the XY stage 18 so that the CCD camera 4 can image the whole divisions C on the microarray A. Then the microarray A is again irradiated with the light rays emitted from the transmission light source 2. The light rays emitted from the transmission light source 2 and passing through the microarray A are imaged by the CCD camera 4 through the objective 14. When all of the divisions C on the microarray A do not fall within the visual field of the CCD camera 4, the microarray A is, in regular sequence, moved using the XY stage 18 in such a manner that each region or group including a predetermined number of divisions C falls within the visual field of the CCD camera 4 to thus image all of the divisions C in order. At this stage, it is desirable that the microarray A is not, in order, moved while taking into consideration, for instance, the accuracy in the movement of the XY stage 18 and all of the divisions C are imaged before imaging the fluorescence emitted from the microarray A, but the fluorescence is desirably imaged after imaging each group of the divisions C and before the XY stage 18 is shifted to image the subsequent group of the divisions C.

Moreover, in case where the divisions C on the microarray A are arranged such that they form a plurality of blocks as shown in FIG. 2B, it is possible to image the divisions C block by block. In this case, the visual field F1 is first so established that the division C1 existing at one corner of a block can certainly be imaged as shown in FIG. 2B and then the microarray A is imaged. Next, the XY stage 18 is shifted to a desired amount and the visual field F2 is established so that the division C2 existing at the corner opposite to the division C1 can certainly be imaged. Then, the microarray A is again imaged. The indexing means 5c secured to the detection means 5 calculates the coordinates of the central point P1 for the whole blocks on the microarray A, on the basis of the central position of the division C1 in the visual field F1, the central position of the division C2 in the visual field F2 and the moving quantity of the XY stage between the visual fields F1 and F2. Moreover, the indexing means 5c calculates the coordinates of the central point P2 of each block arranged on the microarray A based on the number of blocks and the distance between the neighboring blocks. Then the indexing means 5c establishes the visual field F3 on the basis of the coordinates of the central point P2 so that the division C1 existing at one corner of a block can certainly be imaged as shown in FIG. 2C and then the microarray A is imaged. Further the XY stage 18 is shifted to a desired amount and the visual field F4 is established so that the division C3 existing at the corner opposite to the division C1 in the same block can certainly be imaged. Then, the microarray A is again imaged. The indexing means 5c calculates the coordinates of the central point P2 of the blocks, on the basis of the central position of the division C1 in the visual field F3, the central position of the division C3 in the visual field F4 and the moving quantity of the XY stage between the visual fields F3 and F4. Each visual field for imaging each corresponding block is determined based on the coordinates of the central point P2 for each block thus determined.

Thus, all of the divisions C included in each block can be imaged with certainty by determining the visual field for imaging the microarray A in this way. Alternatively, when arranging the divisions C on the microarray Awhile dividing them into a plurality of blocks, the visual field for imaging the microarray A can easily be determined as compared with the case in which a microarray A carrying divisions C arranged thereon without dividing them into blocks is imaged over a plurality of times. Moreover, if the microarray A is imaged block by block after the divisions C present on the microarray A are divided into a plurality of blocks, the divisions C can be imaged while ensuring a high resolution, in comparison with the case in which all of the divisions arranged on the microarray A are imaged at a time.

The spots of the transmitted light rays imaged by the CCD camera 4 are inputted into the detection means 5 for the image analysis and the position and size of each spot are thus determined. Further, in the detection means 5, the size of each spot thus determined is contracted by a desired quantity and the contour of each spot thus contracted is stored in the detection means 5. In this connection, in some applications, the dichroic mirror 8, the absorption filter 10 and the excitation filter 12 may be moved so that they are out of the optical axis of the microscope 16 when imaging the transmitted light rays.

The contraction rate of the spot may appropriately be selected in proportion to the magnitude of the noise generated due to the influence of the base material B in the circumference of the division C and the wall surfaces of the division C. For instance, if the shaped speckle in the proximity to a spot is large and the rate of immobilized probe observed at the center of the spot differs from that observed for the circumference thereof, or if the self-fluorescent characteristics of the wall surface of the base material B or the division C are quite strong, the contraction rate should be increased and, in other words, only the image of the division C in the vicinity to the center thereof is adopted as the image datum. In general, it is desirable to reduce the approximate diameter of the spot to 30 to 100% of the original one. The procedures for reducing the spot diameter by the detection means 5 are the same as those described above in connection with the inspection experiment and therefore, the details thereof are herein omitted.

Moreover, in a microarray of the type such that a probe is directly immobilized on the inner wall of each division or a microarray of the type such that a gel-like substance is coated to only the inner wall of each division, the probe is present only in the vicinity of the inner wall of each division and the region in the proximity to the center thereof is vacant or empty. Therefore, in such a microarray, the intensity of the transmitted light in the proximity to the center of the division is stronger than that observed in the vicinity to the inner wall of the division. When reading the microarray of this type, it is also possible that the picture elements within the spot are further classified on the basis of a second threshold value and the analysis thereof is carried out after the removal of the image corresponding to the portion near the center of the spot or the vacant portion.

After imaging the spots of transmitted light rays, the light from the transmission light source 2 is cut off, the excitation light source 6 is switched on or the shutter for the excitation light source 6 is opened to thus irradiate the microarray A with the excitation light rays emitted from the source 6. The light rays emitted from the excitation light source 6 are incident upon the excitation filter 12 to thus cut off the light rays of wavelengths other than that required for the excitation of the fluorescent material. The excitation light rays which have transmitted through the filter 12 are reflected by the dichroic mirror 8 and the reflected light rays are then directed towards the objective 14 of the microscope 16. The excitation light rays reflected by the dichroic mirror 8 are collected by the objective 14 and the microarray A is irradiated by the collected light.

When the microarray A is irradiated with the excitation light rays, the fluorescent material present on the microarray A is excited by the action of the excitation light and emits fluorescent light rays having a wavelength different from that of the excitation light. The fluorescence emitted from the microarray A passes through the objective 14 and the dichroic mirror 8 and it is then incident upon the absorption filter 10. In this respect, the component having the wavelength of the excitation light, which is reflected by the microarray A and returned back to the dichroic mirror 8, is reflected by the dichroic mirror 8 and therefore, the reflected light is scarcely incident upon the absorption filter 10. The absorption filter 10 allows the component having the wavelength of the fluorescence emitted from the fluorescent material present on the microarray A, among the light rays incident upon the absorption filter to transmit through the same, while the filter 10 cuts off the light component having the wavelength of the excitation light. The fluorescence which passes through the absorption filter 10 is imaged by the CCD camera 4.

The spot images of the fluorescence emitted from the fluorescent material present on the microarray A, which are imaged by the CCD camera 4, are subjected to the shading correction on the basis of the diffusion images which have previously been imaged and stored in the detection means 5. In other words, the speckles representing the quantity of the excitation light applied to the microarray A are numerically corrected by the detection means 5.

Moreover, images may sometimes undergo a deviation of their position due to the presence or absence of an optical system, for instance, the deviation of the optical axes of the dichroic mirror 8, the absorption filter 10 and the excitation filter 12 from that of the microscope 16 when imaging the transmitted light, or due to the aberration of an optical system even when the foregoing parts are in line with the microscope. The correction means 5a of the detection means 5 stores these deviations in advance and can thus correct, for instance, the focusing position for picking up images and the positions of the fluorescence images and the spot images on the basis of the deviations stored in the means. Then the images representing the contours of the transmitted light spots previously imaged and stored in the detection means 5 are superimposed on the spot images of the fluorescence obtained after the shading correction. The detection means 5 averages CCD-read values for the picture elements within the contour line of each fluorescence spot to thus determine the average CCD-read value for the spot. Thus, the quantity of the hybrid formed from the specimen to be analyzed and each probe can be determined based on the resulting average CCD-read value.

Moreover, the means 5b for masking the detection means 5 cuts off unnecessary portion of the image from the spot image of the fluorescence obtained after the shading correction based on the contour of the spot of the transmitted light stored in the detection means 5 in advance. The image thus subjected to a masking treatment permits the reduction of the storage capacity by a compression processing.

The microarray-reading device according to the first or second embodiment of the present invention permits the preliminary recognition of the position on a microarray at which a specific division is disposed and therefore, the device permits the precise discrimination of a specific probe which forms a product with the specimen and emits the detected fluorescence even when using a specimen whose fluorescence intensity is low or a microarray whose accuracy in the arrangement is low. Moreover, spots of transmitted light rays imaged by a CCD camera are contracted and a part of the spot image is used for the analysis of the fluorescence. Therefore, the device permits the effective elimination of any influence of the noise other than the fluorescence emitted from the desired fluorescent material such as the auto-fluorescence of the division in itself.

In the foregoing first or second embodiment, one kind of fluorescent material is incorporated into a microarray, but a plurality of fluorescent materials which can emit fluorescent light rays having different wavelengths can likewise be applied onto one microarray simultaneously. In this case, the device is suitably be designed in such a manner that the combination of a dichroic mirror 8, an absorption filter 10 and an excitation filter 12 can appropriately be exchanged by the control device 20 in response to the wavelengths of the fluorescent light rays to be detected. In case where a delicate deviation of the spot image-forming position is observed because of the exchange of the combination of a dichroic mirror 8, an absorption filter 10 and an excitation filter 12, the device may be so designed that such deviations are determined in advance and that the deviation can be corrected depending on each particular combination of, for instance, filters.

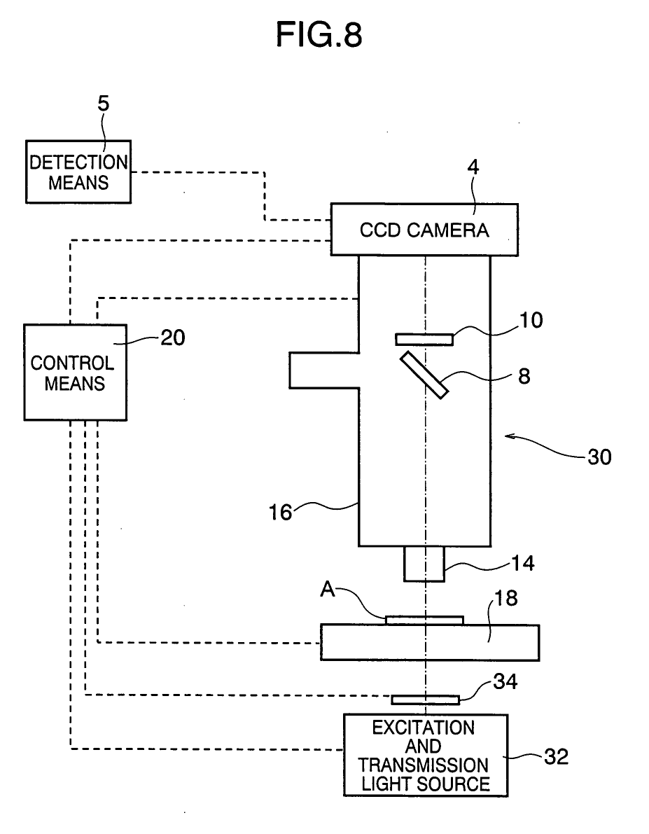

Next, the microarray-reading device according to a third embodiment of the present invention will be described in detail below with reference to FIG. 8. The microarray-reading device 30 according to the third embodiment of the present invention has almost the same structure used in the foregoing embodiments except that one light source is used both as a transmission light source and an excitation light source. Accordingly, only the points in which the third embodiment and the first and second embodiments differ from one another will hereunder be explained and the explanation of the same construction, operations and effects will be omitted.

FIG. 8 is a schematic block diagram illustrating the microarray-reading device 30 according to the third embodiment of the present invention. As shown in FIG. 8, the microarray-reading device 30 according to the third embodiment of the present invention comprises a transmission and excitation light source 32 for emitting light rays capable of transmitting through the microarray A, and for emitting excitation light rays capable of exciting the fluorescent material and an excitation filter 34 for filtering the light rays emitted from the light source 32. Furthermore, the microarray-reading device 30 also comprises a CCD camera 4 for imaging transmitted light rays and fluorescence and a detection means 5 for analyzing a specimen.

In addition, the microarray-reading device 30 is provided with a microscope 16 which is likewise equipped with a dichroic mirror 8, an absorption filter 10 and an objective 14. Moreover, the microarray-reading device 30 comprises an XY stage 18 for moving the microarray A to a desired position on a horizontal plane; a focusing stage (not shown) for vertically moving the XY stage 18 or the objective 14 for the control of the transmission and excitation light source 32, the CCD camera 4 and the distinctness of the image of the microarray A taken by the CCD camera; and a control device 20 for controlling the XY stage 18.

In this embodiment, the transmission and excitation light source 32 and the excitation filter 34 are arranged below the XY stage 18. The excitation filter 34 is so designed as to allow only the light rays having a wavelength capable of exciting the fluorescent material present on the microarray A to transmit through the same.

The other components or constituting elements of the third embodiment of the present invention are the same as those used in the foregoing embodiments and therefore, the explanation thereof will be omitted.

Then the microarray-reading device according to a fourth embodiment of the present invention will be detailed below. The structure of the microarray-reading device according to a fourth embodiment of the present invention is identical to that of the microarray-reading device according to the third embodiment of the present invention and therefore, the explanation thereof will be omitted. Subsequently, the operations of the microarray-reading device 30 according to a fourth embodiment of the present invention will be described below. First of all, when irradiating the microarray A with the transmitted light, the excitation filter 34 is disconnected from the optical circuit or the optical axis of the device and the microarray A is directly irradiated with the transmission light rays emitted from the transmission and excitation light source 32. The light rays emitted from the light source 32 and applied to the microarray A transmit through the microarray A and the transmitted light is then imaged by the CCD camera 4. If the fluorescent material on the microarray A is excited by the light rays emitted from the light source 32, the excitation filter 34 is again connected to the optical circuit or disposed in the optical axis and the excitation light having a wavelength capable of exciting the fluorescent material are applied to the microarray A from the lower direction. In addition, the excitation light which transmits through the microarray A is reflected by the dichroic mirror 8 so that the reflected light is thus deflected from the optical axis of the light incident upon the CCD camera 4. The fluorescence emitted from the fluorescent material which is excited by the application of the excitation light thereto transmits through the dichroic mirror 8 and the absorption filter 10 and it is then incident upon the CCD camera 4. The points other than the foregoing are the same as those discussed above in connection with the foregoing embodiments and therefore, the explanation thereof will be omitted.

This embodiment would permit the use of a single light source both as a transmission light source and an excitation light source. Moreover, the excitation light is applied to the microarray A from the lower direction thereof and therefore, only the light rays transmitting through the division C on the microarray A are incident upon the microscope 16. For this reason, the light rays reflected from the substrate portion B of the microarray A among the excitation light rays incident upon the microarray A are never incident upon the microscope 16, unlike the foregoing first or second embodiment. Thus, this embodiment would permit the considerable improvement of the S/N ratio for the fluorescence to be detected.

A method for reading the information of a microarray as a fifth embodiment of the present invention will hereunder be described in detail.

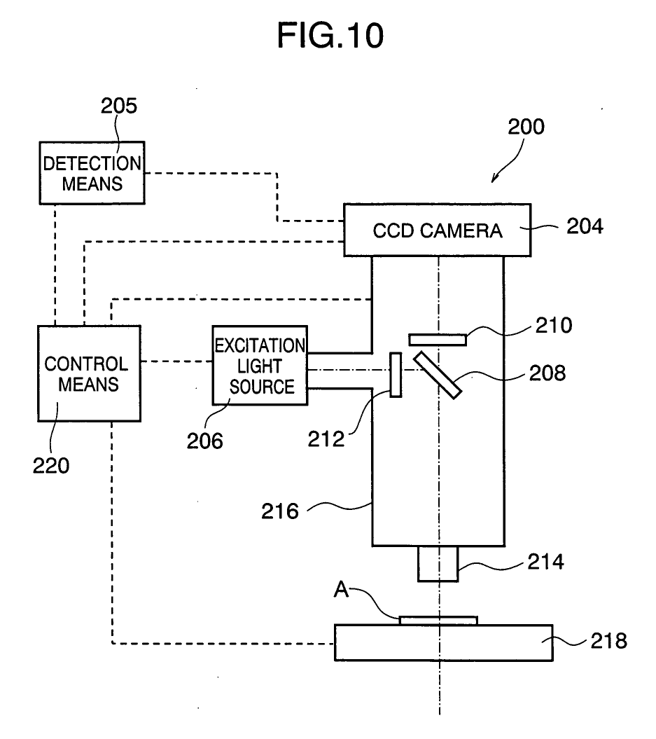

FIG. 10 is a schematic block diagram illustrating a device for conducting reading of a microarray, which makes use of a fluorescence microscope and which may be used in the microarray-reading method according to this embodiment.

As will be seen from FIG. 10, the microarray-reading device 200 which conducts the reading of a microarray using a fluorescence microscope 216 comprises an excitation light source 206 for applying light rays capable of exciting a fluorescent material to the microarray A; a CCD camera 204 as an imaging means for converting, into an image, the fluorescence emitted from the fluorescent material attached to a specimen present on the microarray A; and a detection means 205 for analyzing the specimen on the basis of the image taken by the CCD camera 204.

Moreover, the fluorescence microscope 216 is provided with an optical system which is constituted by a dichroic mirror 208 for transmitting or reflecting desired light rays; an absorption filter 210; an excitation filter 212; and an objective 214 for the microarray A. Further, the microarray-reading device 200 also comprises an XY stage 218 for supporting the microarray A and for moving the same to a desired position on a horizontal plane; a focusing stage (not shown) for vertically moving the XY stage 218 or the objective 214 in order to adjust the distinctness of the image of the microarray A to be imaged by the CCD camera 204; and a control device 220 for controlling, for instance, the XY stage 218.

In addition, the excitation light source 206 is so arranged that it can emit light rays into the body tube of the microscope 216 through the side of the tube. It is herein preferred to select a light source containing a large quantity of components having wavelengths capable of exciting the fluorescent material present on the microarray A, as the excitation light source 206. In this embodiment, a high pressure mercury lamp is used as the excitation light source 206.

The excitation filter 212 is so designed that it can pass only the component having wavelengths capable of exciting the fluorescent material present on the microarray A among the light rays emitted from the excitation light source 206 and that it can cut off all of the other components of the light rays emitted from the source. On the other hand, the absorption filter 210 is so designed that it can pass only the light rays having a wavelength identical to that of the fluorescence outputted from the microarray A, but it inhibits the transmission of any component of light having a wavelength capable of exciting the fluorescent material. The dichroic mirror 208 is so designed and arranged that it can reflect and direct, to the microarray A, the light rays which have passed through the excitation filter 212 and which have wavelengths capable of exciting the fluorescent material. Moreover, this dichroic mirror 208 is likewise so designed as to pass light rays having a wavelength identical to that of the fluorescence emitted from the fluorescent material present on the microarray A.

In this embodiment, Cy3 is used as such a fluorescent material. As the absorption filter 210, the excitation filter 212 and the dichroic mirror 208 used herein were a commercially available filter set for Cy3. In this respect, the light-reflection and light-transmission characteristics of the absorption filter 210, the excitation filter 212 and the dichroic mirror 208 are identical to those observed for these members used in the first embodiment.

The CCD camera 204 is attached to the end of the body tube of the fluorescence microscope 216 opposite to the objective 214 in such a manner that the optical axis of the former is completely consistent with that of the fluorescence microscope 216. The details of the CCD camera 204 herein used are the same as those used in the first embodiment and therefore, the explanation thereof will be omitted herein.

The XY stage 218 is so designed that it can move the microarray A on a horizontal plane whereby the CCD camera 204 can image any portion on the microarray A. A focusing stage (not shown) is so designed that it can vertically move the XY stage 218 or the objective 214 to thus focus the image of the microarray A photographed by the CCD camera 204. Moreover, the control device 220 serves to control, for instance, the imaging operations by the CCD camera 204; the movement of the XY stage 218; the ON/OFF switching of the excitation light source 206; and the movement of the focusing stage. Alternatively, when using a light source of a type unfavorable for the applications, wherein the ON/OFF operations are frequently repeated, as the excitation light source 206, a shutter (not shown) for cutting off any light is positioned in front of the excitation light source 206 and the opening and shutting operations of the shutter are controlled by the control device 220. The control device 220 is constituted by, for instance, actuators for operating every devices and a personal computer for sending signals to the actuators.

Incidentally, the microarray A used in the microarray-reading operation according to the embodiment of the present invention is identical to that used in the first or second embodiment of the present invention and therefore, the details thereof are not described herein.

Then the microarray-reading method according to the embodiment of the present invention will be described below.

First, a microarray A is prepared, in which a gel-like substance containing a probe is introduced in each division of the microarray. Alternatively, in some applications, a probe is directly immobilized to the inner wall of each division C. On the other hand, a specimen to be analyzed labeled with a fluorescent material, followed by applying the specimen on the microarray A. When a certain specimen acts on a probe, the specimen undergoes a reaction with the probe to thus form a reaction product and therefore, the fluorescent material attached to the specimen is immobilized in the division C on the microarray A. This clearly indicates that the fluorescent material is present only in the division C which comprises the desired probe having a structure capable of forming a hybrid with the specimen to be analyzed.

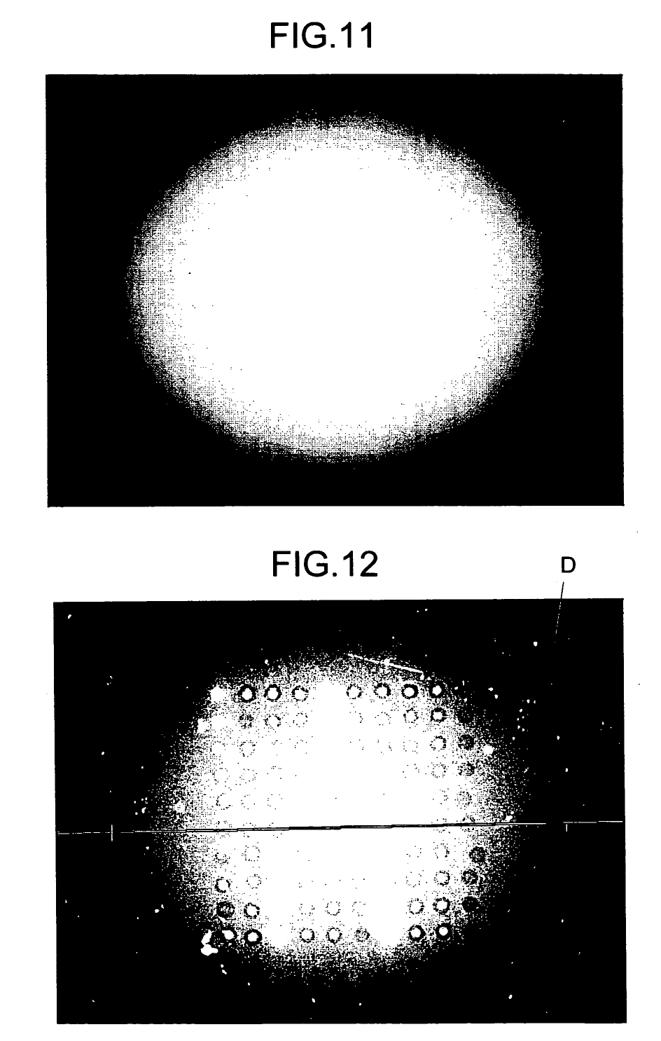

Prior to the initiation of the reading of the microarray A, the XY stage 218 of the microarray-reading device 200, on which any load is not present, is irradiated with the light rays from the excitation light source 206 the light rays detected at this stage are imaged by the CCD camera 204. In this respect, the portion on the XY stage 218 irradiated with the excitation light through the objective 214 is desirably designed in such a manner that it does not cut off the excitation light rays and thus it is transparent to the excitation light. The images thus obtained include not only the information representing the light quantity speckle of the excitation light source 206, but also the information representing the noise light imaged by the CCD camera 204 as the light rays other than the fluorescence emitted from the microarray A, when performing the measurement of the fluorescence from the microarray A and therefore, they are stored in the detection means 205 as correction images 100. FIG. 11 shows an example of such a correction image 100 photographed by the CCD camera 204. In addition, it is preferred for the elimination of any noise originated from, for instance, the dark current of the CCD camera 204 that an image for dark current-correction is prepared by operating the CCD camera 204 under such a condition that the excitation light source 206 is switched off or the shutter is closed so that any excitation light is not applied and that the resulting image for dark current-correction is subtracted from the correction image 100 to thus give a correction image practically used. In other words, the datum for each picture element corresponding to the dark current-correction image is subtracted from the datum for each picture element constituting the correction image 100 and the resulting datum is used as a new correction image. Incidentally, the exposure time used for imaging the image for dark current-correction is set at the same level used for imaging the correction image 100.

Then the microarray A is fitted to the XY stage 218. In this case, if the position of the stage 218 when fitting the microarray A thereto differs from that of the stage 218 when conducting the measurement of the microarray A, the XY stage 218 is moved to the position for the measurement.

Then the microarray A set up on the XY stage 218 is irradiated with the excitation light rays emitted from the excitation light source 206 and the fluorescence generated by the fluorescent material immobilized on the gel-like substance which is held in each division C arranged on the microarray A is imaged by the CCD camera 204. The images thus obtained are stored in the detection means 205 as fluorescence images 101. In addition, it is preferred for the elimination of any noise originated from, for instance, the dark current of the CCD camera 204 that an image for dark current-correction is prepared and that the resulting image for dark current-correction is subtracted from the fluorescence image 101 to thus give a net fluorescence image practically used. Incidentally, the exposure time used for imaging the image for dark current-correction is set at the same level used for imaging the fluorescence image 101. FIG. 12 shows an example of the fluorescence image 101 obtained by the CCD camera 204.

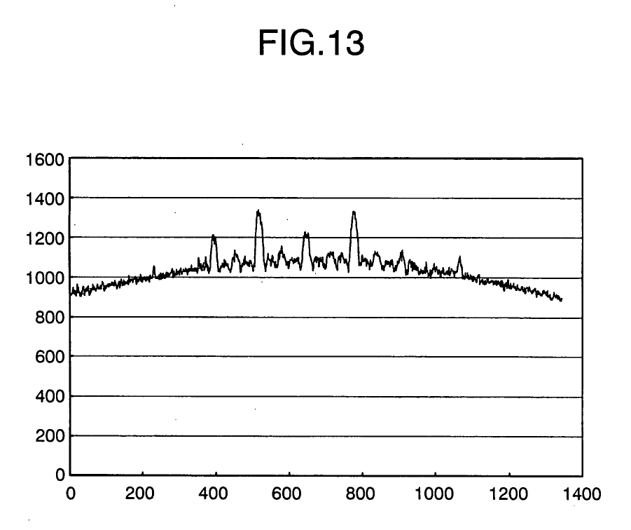

The fluorescence image 101 comprises the light quantity speckle originated from the excitation light source 206 and the stray light due to the reflection by, for instance, various lenses constituting the fluorescence microscope 216 and, in particular, when the wavelength of the excitation light and that of the fluorescence are very close to one another, it is quite difficult to completely separate the excitation light from the fluorescence due to the characteristics of the excitation filter 212, the dichroic mirror 208 and the absorption filter 210, this in turn leads to an increase of the background due to the foregoing stray light and as a result, the S/N ratio is correspondingly reduced. FIG. 13 shows the line profile along the line D on the image shown in FIG. 12.

In this connection, the foregoing stray light is principally generated due to, in particular, the following fact: the excitation light reflected by the lenses constituting the objective 214 is reduced, but is not completely removed by the characteristic properties of the dichroic mirror 208 and the absorption filter 210 and thus a part thereof is incident upon the CCD camera 204. The intensity distribution of the stray light is approximately in proportion to the intensity of the correction image 100. In addition, the correction image 100 is likewise approximately proportional to the intensity distribution of the excitation light applied to the microarray A.

Then the correction image 100 multiplied by a desired value is subtracted from the fluorescence image 101 and the resulting image is stored in the detection means 205 as a stray light-corrected fluorescence image 102. In other words, the stray light-corrected fluorescence image 102 is defined to be a value obtained by subtracting the pixel datum corresponding to the correction image 100 multiplied by a predetermined value from each pixel datum of the fluorescence image 101. This operation would permit the removal of the part corresponding to the foregoing stray light from the image.

Thereafter, to correct the fluorescent light speckle due to the excitation light speckle, the correction image 100 is subtracted from the stray light-corrected fluorescence image 102, the resulting value is multiplied by the average of the correction image 100 and the value thus obtained is stored in the detection means 205 as the fluorescence image 103 corrected for the stray light and excitation light speckle. In this respect, it is desirable that the pixel data of each image be processed according to such an arithmetic as a floating-point operation to thus obtain the fluorescence image 103 corrected for the stray light and excitation light speckle. In the foregoing method, the average of the correction image 100 is multiplied, but the present invention is not restricted to such a method. For instance, a maximum, a minimum or a constant value may be multiplied and when a constant value is multiplied, the fluorescence image may be corrected to give one to which the same level of excitation light is applied even when the intensity of the excitation light is reduced due to a change of the excitation light source 206 with time.

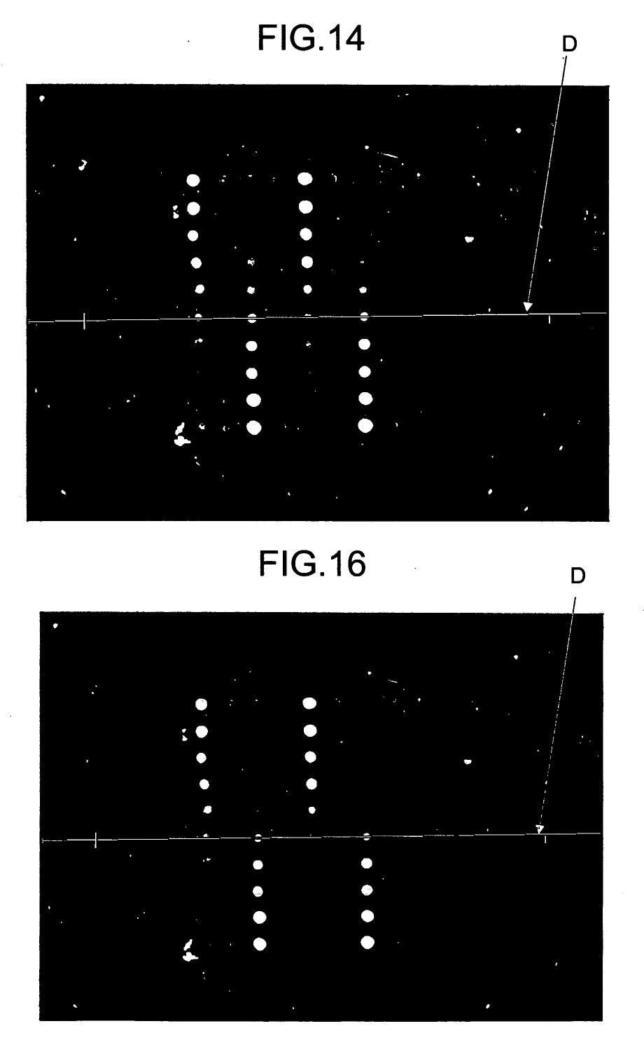

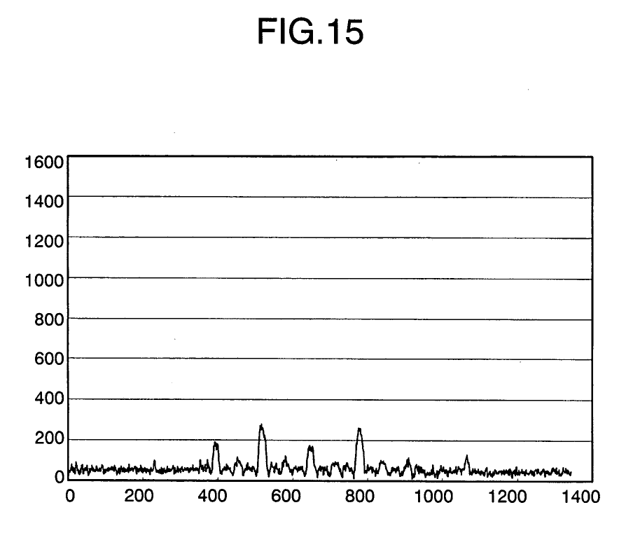

FIG. 14 shows fluorescence images corrected for the stray light and excitation light speckle. This fluorescence image corrected for the stray light and excitation light speckle can be obtained according to the following procedures. First of all, the correction image shown in FIG. 11 is multiplied by a value corresponding to [(the exposure time for the fluorescence image shown in FIG. 12)/(the exposure time for the correction image shown in FIG. 11)] to thus prepare an exposure time-correction image. Then the exposure time-correction image is subtracted from the fluorescence image shown in FIG. 12 to give a subtracted image. Further, the correction image shown in FIG. 11 is subtracted from this subtracted image and then the resulting value is multiplied by the average of the correction image shown in FIG. 11 to thus give a fluorescence image corrected for the stray light and excitation light speckle. In addition, FIG. 15 shows the line profile observed along the line D on the image shown in FIG. 14. In the foregoing procedures, the correction image shown in FIG. 11 is multiplied by a value corresponding to [(the exposure time for the fluorescence image shown in FIG. 12)/(the exposure time for the correction image shown in FIG. 11)] to thus prepare an exposure time-correction image, but the value to be multiplied is not limited to the foregoing one and can be established or selected on the basis of the relation between the correction image 100 and the intensity of stray light.

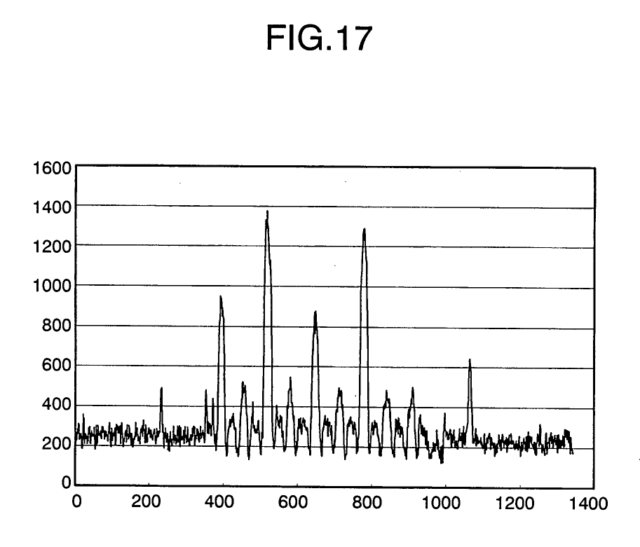

The operations discussed above permit the preparation of an image which is almost free of any influence of stray light rays and excitation light speckles and whose S/N ratio is considerably improved. In case where the stray light is in a high level, however, any sufficient exposure time cannot be ensured because of the saturation of the CCD camera 204 and for this reason, it is sometimes difficult to determine any division whose fluorescent intensity is low. Thus, a plurality (n) of fluorescence images 101-1, 101-2, . . . , 101-n can be taken using an exposure time falling within the range in which the CCD camera never undergoes saturation, each image can be subjected to the foregoing corrections for stray light rays and excitation light speckles and further the resulting corrected n images can be summed up to extend the apparent exposure time and to thus determine the division whose fluorescent intensity is low. The image obtained by summing up the foregoing n fluorescence images corrected for stray light rays and excitation light speckles is stored in the detection means 205 as an n-summed up, stray light and excitation light speckle-corrected fluorescence image 104-n. FIG. 16 shows the results obtained when setting n at 5 or the results obtained by obtaining 5 fluorescence images under the same conditions used for imaging the fluorescence images shown in FIG. 12 and subjecting the resulting 5 images to the same processing used above to give a 5-summed up, stray light and excitation light speckle-corrected fluorescence image. In addition, FIG. 17 shows the line profile observed along the line D on the image shown in FIG. 16. In the foregoing procedures, a plurality of fluorescence images are taken at an exposure time falling within the range in which the CCD camera never undergoes saturation, but the exposure time may be set at a level falling within the range in which the CCD camera undergoes saturation in the division whose fluorescence intensity is high. In this case, the measured values obtained for the divisions in which the CCD camera causes saturation are neglected, while the divisions having a low fluorescence intensity are highly accurately analyzed, by extending the exposure time and imaging a plurality of fluorescence images. In this respect, however, such a longer exposure time is selected such that the saturation observed for the divisions having a high fluorescence intensity never adversely affects the desired other divisions to be analyzed.

First, there are imaged by the CCD camera 204 fluorescence images of divisions having a strong fluorescence intensity: 101-1(X), 101-2(X), . . . , 101-n(X) at an exposure time (X) falling within the range in which the CCD camera never cause saturation; and fluorescence images: 101-1(Y), 101-2(Y), . . . , 101-n(Y) at an exposure time (Y) falling within the range in which the divisions having a low fluorescence intensity can accurately be analyzed. Then each fluorescence image is subjected to the foregoing correction for stray light rays and excitation light-irradiation speckles as well as the foregoing treatment of adding n stray light and excitation light speckle-corrected images to thus obtain multi-exposure time, n-summed up, stray light and excitation light speckle-corrected fluorescence images 104-n(X), 104-n(Y) and these images are stored in the detection means 205.

The reading of the microarray A is conducted on each of the divisions on the microarray A. The reading should be performed on the stray light and excitation light-irradiation speckle-corrected fluorescence images 103, or the n-summed up, stray light and excitation light speckle-corrected fluorescence images 104-n, or the multi-exposure time, n-summed up, stray light and excitation light speckle-corrected fluorescence images 104-n(X), 104-n(Y). In the reading of the multi-exposure time, n-summed up, stray light and excitation light speckle-corrected fluorescence images 104-n(X), 104-n(Y), it is read from the multi-exposure time, n-summed up, stray light and excitation light speckle-corrected fluorescence images 104-n(Y) when the fluorescence images 101-m(Y), wherein m=1, 2, . . . , n, are not saturated at all within the divisions to be read, while it is read from the multi-exposure time, n-summed up, stray light and excitation light speckle-corrected fluorescence images 104-n(X) when the fluorescence images 101-m(Y) undergo saturation in the range specified above. Since the CCD camera 204 shows characteristic properties linear with respect to the exposure time, the read value of the multi-exposure time, n-summed up, stray light and excitation light speckle-corrected fluorescence images 104-n(X) is multiplied by a factor Y/X to thus coordinate the read value of the image 104-n(X) and that of the image 104-n(Y). An example, wherein two different exposure times X and Y are selected for the multiple exposure time, is herein described, but it is likewise possible to select a large number of exposure times of more than 2 as the multiple exposure time.

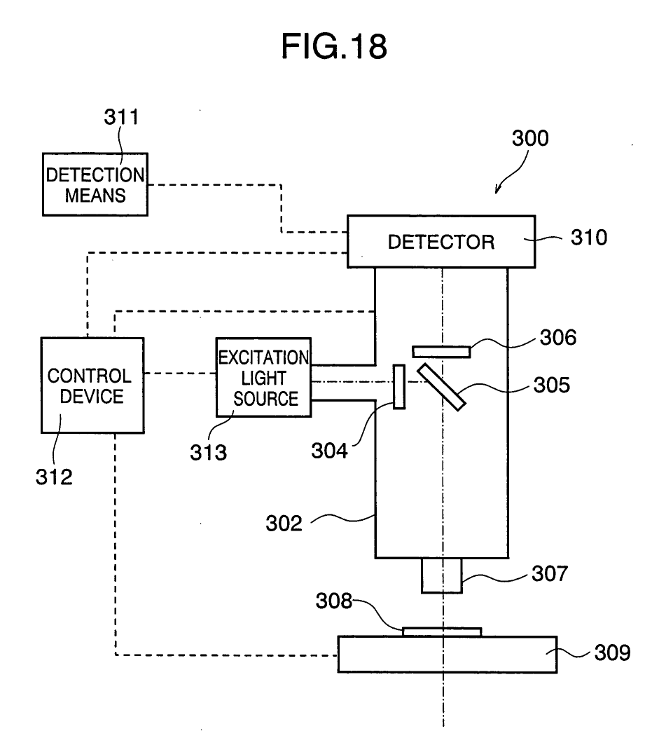

Referring now to FIG. 18, the shading correction method according to the sixth embodiment of the present invention will hereunder be described in detail.

FIG. 18 is a schematic block diagram illustrating an example of the structure of an incident light-type excitation fluorescence detector 300 which makes use of an incident light-type fluorescence microscope 302.

This incident light-type excitation fluorescence detector 300 which makes use of an incident light-type fluorescence microscope 302 comprises an excitation light source 303 for applying fluorescent material-exciting light rays to a sample 308 to be analyzed such as the microarray A; a detector 310 as a means for imaging the fluorescence emitted from the fluorescent material included in the sample 308; and a detection means 311 for carrying out analysis on the basis of the data imaged by the detector 310.

Moreover, the incident light-type fluorescence microscope 302 used herein is equipped with an optical system, which comprises a dichroic mirror 305 for transmitting or reflecting desired light rays; an absorption filter 306; an excitation filter 304; and an objective 307 for the sample 308 to be analyzed. The incident light-type excitation fluorescence detector 300 further comprises an XY stage 309 for supporting the sample 308 to be analyzed and for moving the sample to a desired position on a horizontal plane; a focusing stage (not shown) for vertically moving the XY stage 309 or the objective 307 to focus the image of the sample taken by the detector 310; and a control device 312 for controlling, for instance, the XY stage 309.

In addition, the excitation light source 303 is so arranged that it can emit light rays into the body tube of the fluorescence microscope 302 through the side of the tube. It is herein preferred to select a light source containing a large quantity of components having wavelengths capable of exciting the fluorescent material present in the sample 308 to be analyzed, as the excitation light source 303. In this embodiment, a high pressure mercury lamp is used as the excitation light source 303.

The excitation filter 304 is so designed that it can pass only the component having wavelengths capable of exciting the fluorescent material present in the sample 308 to be analyzed among the light rays emitted from the excitation light source 303 and that it can cut off all of the other components of the light rays emitted from the source. On the other hand, the absorption filter 306 is so designed that it can pass only the light rays having a wavelength identical to that of the fluorescence outputted from the sample 308 to be analyzed, but it inhibits the transmission of any component of light having a wavelength capable of exciting the fluorescent material. The dichroic mirror 305 is so designed and arranged that it can reflect and direct, to the sample 308, the light rays which have passed through the excitation filter 304 and which have wavelengths capable of exciting the fluorescent material. Moreover, this dichroic mirror 305 is likewise so designed as to pass light rays having a wavelength identical to that of the fluorescence emitted from the fluorescent material included in the sample 308 to be analyzed.

In this embodiment, Cy3 is used as such a fluorescent material. As the absorption filter 306, the excitation filter 304 and the dichroic mirror 305 used herein are a commercially available filter set for Cy3. In this respect, the characteristic properties of these members are identical to those observed for the same members used in the first embodiment and therefore, the details thereof are herein omitted. In this connection, the dichroic mirror 305, the absorption filter 306 and the excitation filter 304 are selected and constituted, while taking into consideration the wavelength of the light for the excitation of the fluorescent material used and the wavelength of the fluorescence emitted by the fluorescent material and if a plurality of fluorescent materials are used, they are desirably so designed that they can easily be switched in the incident light-type fluorescence microscope.

In this embodiment, the detector 310 used is a two-dimensional CCD camera. The CCD camera is secured to the end of the body tube of the incident light-type microscope 302 opposite to the objective 307 in such a manner that the optical axis of the camera is completely coordinated with that of the microscope 302. Preferably, the CCD camera used herein should be one provided with a function of cooling the camera so that feeble fluorescence emitted from the sample 308 to be analyzed can be imaged or detected while maintaining the noise to a quite low level. The CCD camera used in this embodiment is one having 1280×1024 effective picture elements and cooled at −20° C. upon its practical use. In addition, the incident light-type fluorescence microscope 302 used in this embodiment employs an objective with a magnification of ×2 and an image-forming lens with a magnification of ×0.5 is positioned in front of the CCD camera and therefore, in this embodiment uses an optical system having a magnification of ×1.

The XY stage 309 is so designed that it can move the sample 308 to be analyzed on a horizontal plane whereby the CCD camera 308 can image any portion of the sample 308. A focusing stage (not shown) is likewise so designed that it can vertically move the XY stage 309 or the objective 307 to thus focus the image of the sample 308 photographed by the CCD camera. Moreover, the control device 312 serves to control, for instance, the imaging operations by the CCD camera; the movement of the XY stage 309; the ON/OFF switching of the excitation light source 303; and the movement of the focusing stage. Alternatively, when using a light source of a type unfavorable for the applications, wherein the ON/OFF operations are frequently repeated, as the excitation light source 303, a shutter (not shown) for cutting off any light transmission in the region extending from the excitation light source 303 to the excitation filter is disposed and the opening and shutting operations of the shutter are controlled by the control device 312. The control device 312 is constituted by, for instance, actuators for operating every devices and a personal computer for sending signals to the actuators.

Then the shading-correction method according to an embodiment of the present invention will be detailed below.

In a first step, the device is subjected to the analysis operations while any sample is not loaded on the device to thus obtain background data for the device in itself.

A state is realized in which nothing is set on the XY stage 309 or the XY stage is moved so that a portion of the XY stage 309, on which nothing is loaded, is positioned on the optical axis of the objective or moved to realize the state in which nothing is set on the XY stage 309. At this stage, the XY stage is moved in such a manner that there is not anything at the position on the stage 309 corresponding to the visual field of the objective.

Then the excitation light source 303 is switched on or the shutter not shown is opened and the excitation light rays are applied to the stage through the objective. The excitation light outputted from the objective passes through the load-free portion on the XY stage 309 and it illuminates the portions behind the XY stage 309. At this stage, it is ideal that any excitation light is not reflected by the portions behind the stage 309 and therefore, the occurrence of any reflection should be inhibited by ensuring a spatial distance as long as possible or by elaborating any means for enclosing or trapping any reflected light or by the use of a member such as an antireflection sheet.

The CCD camera used as the detector 310 is exposed to the light over an appropriate exposure time of a seconds and the picture element data L_{BG} thus observed for the CCD camera are stored therein.

On the other hand, the excitation light source 303 is switched off or the shutter not shown is closed and the picture element data D_{BG} thus observed for the CCD camera under such a completely light ray-free condition are stored therein. Then the following arithmetic operation is performed and the resulting data BG are stored:

BG=(L_{BG}−D_{BG})/a

The data BG stored herein are the stray light which is generated on the excitation filter 304, dichroic mirror 305, the absorption filter 306, the objective 307 and the optical path connecting these members due to the reflection of the excitation light and which is detected by the detector 310 because of the characteristic properties of the excitation filter 304, dichroic mirror 305 and the absorption filter 306, in case where any reflection of the excitation light behind the XY stage 309 is suppressed. Therefore, the value of the datum BG should by nature zero and accordingly, this is defined to be the background of the device in itself at a unit exposure time.

As a second step, the device is subjected to the analysis operations to obtain data for correcting any shading.

More specifically, a reference reflecting plate having a predetermined reflectivity is disposed on the sample-setting position of the XY stage 309 or the XY stage 309 is moved so that a reference reflecting plate having a predetermined reflectivity and preliminarily placed at a position other than the sample-setting position of the XY stage 309 hold a position on the stage opposite to the objective 307.

Then the excitation light source 303 is switched on or the shutter not shown is opened and the excitation light rays are applied to the stage through the objective. The excitation light incident upon the stage through the objective is applied onto the reflecting plate on the XY stage 309 and the excitation light reflected by the reflecting plate is directed to the dichroic mirror 305 through the objective 307. The dichroic mirror 305 can ideally reflect the entire components having the wavelength of the excitation light, but it in fact transmits a part of the same. On the other hand, the absorption filter 306 can ideally transmit only the light having the wavelength of the desired fluorescence and cut off the components having wavelengths other than those of the fluorescence. In particular, however, when the wavelength of the excitation light and that of the fluorescence are quite close to one another, it is impossible to completely cut off the light having the wavelength of the excitation light and as a result, the excitation light reflected by the reflecting plate is detected by the detector 310 although the quantity thereof is extremely low.

The CCD camera used as the detector 310 is exposed to the light over an appropriate exposure time of b seconds and the picture element data L_{w} thus observed for the CCD camera are stored therein.

On the other hand, the excitation light source 303 is switched off or the shutter not shown is dosed and the picture element data D_{W} thus observed for the CCD camera under a completely light ray-free condition for the same exposure time of b seconds are stored therein. Then the following arithmetic operation is performed and the resulting data W are stored:

W={(L_{W}−D_{W})/b}−BG

In this equation, (L_{W}−D_{W}) represents the background of the device in itself observed for an exposure time of b seconds and the light reflected by the reference reflecting plate and detected by the detector 310. This value is then divided by b to thus obtain a datum per unit exposure time and further the background of the device in itself per unit exposure time is subtracted therefrom to thus give the excitation light distribution W reflected by the reflecting plate and detected by the detector 310 within a unit exposure time. This excitation light distribution W is proportional to the distribution of the excitation light applied to the stage through the objective 307 at the sample-setting position and this is used as the datum for the shading correction.

In the third step, the fluorescent signal data outputted from the sample are subjected to the correction concerning the background of the device in itself and the shading correction to thus obtain the fluorescence data.

More specifically, a sample 308 to be analyzed is placed on the sample-setting position of the XY stage 309 and the stage 309 is moved in such a manner that the sample 308 hold a position on the stage opposed to the objective 307.

Then the excitation light source 303 is switched on or the shutter not shown is opened and the excitation light rays are applied to the stage through the objective. The excitation light incident upon the stage through the objective is applied onto the sample 308 to be analyzed, which is placed on the XY stage 309 and the excitation light reflected by the sample 308 and the fluorescence generated by the sample 308 are directed to the dichroic mirror 305 through the objective 307. The dichroic mirror 305 can ideally reflect the entire components having the wavelength of the excitation light, but it, in fact, partially transmits the same. On the other hand, the absorption filter 306 can ideally transmit only the light having the wavelength of the fluorescence and cut off the components having wavelengths other than those of the fluorescence. In particular, however, when the wavelength of the excitation light and that of the fluorescence are quite close to one another, it is impossible to completely cut off the light having the wavelength of the excitation light and as a result, the excitation light reflected by the sample 308 is detected by the detector 310 together with the fluorescence generated by the sample 308 although the quantity thereof is extremely low. For this reason, the sample 308 should be prepared from a material whose reflectivity with respect to the light having the wavelength of the excitation light is preferably in a level as low as possible.

The CCD camera used as the detector 310 is exposed to the light over an appropriate exposure time of c seconds and the picture element data Lₛ thus observed for the CCD camera are stored therein.

On the other hand, the excitation light source 303 is switched off or the shutter not shown is closed and the picture element data Dₛ thus observed for the CCD camera under a completely light ray-free condition for the same exposure time of c seconds are stored therein. Then the following arithmetic operation is performed and the resulting data S are stored:

S=[{(Lₛ−Dₛ)/c}−BG]×m/W

In this equation, (Lₛ−Dₛ) represents a difference between the background of the device in itself observed for an exposure time of c seconds and the datum detected by the detector 310, which comprises the fluorescence emitted by the sample 308 and a part of the excitation light reflected by the sample and detected by the detector 310. This value is then divided by c to thus obtain a datum per unit exposure time and further the background of the device in itself per unit exposure time is subtracted therefrom to thus give intensity data of the fluorescence generated by the sample 308 and detected by the detector 310 within the unit exposure time. In this respect, however, it is assumed that the excitation light reflected by the sample 308 is in a negligible level. This excitation light distribution W is proportional to the distribution of the excitation light applied to the stage through the objective 307 at the sample-setting position and this is used as the datum for the shading correction. These fluorescence intensity data are those observed when excitation light-irradiation distribution speckles are present and the fluorescence intensity is proportional to the intensity of the excitation light applied. Accordingly, the data W for the shading correction in proportion to the excitation light-irradiation distribution previously stored are subtracted from these fluorescence intensity data to thus give corrected fluorescence intensity data S. In this respect, m is a constant and the usually used value of m is on the order of the average of the shading correction data W. The value of m is not necessarily varied for the revision of the data W for the shading-correction, but it is desirably set at a constant level when used in the same optical system. For this reason, the fluorescence intensity data S ultimately obtained are corrected with respect to the influence of the reduced excitation light intensity even when there is observed any reduction of the excitation light intensity due to, for instance, the deterioration of the excitation light source 303.

The arithmetic operation corresponding to [{(Lₛ−Dₛ)/c}−BG] in the foregoing equation is preferably conducted prior to the conversion of the analog outputs from the detector 310 into their digital values by an A/D converter since this permits the full use of the intensity level of the A/D conversion. When the data outputted from the detector 310 are obtained in the already A/D-converted form as correction-free data, the digital data thereof include, for instance, the background of the device in itself and dark current noises generated under such a condition that any light rays are not incident upon the detector 310 and therefore, all of the intensity level of the A/D conversion are not used as data, but the dynamic range can be corrected by integrating a plurality of exposure data which are subjected to the correction according to the present invention.

What is claimed is:

1. A device for reading fluorescent light rays emitted from a fluorescent material incorporated into a multiple divisions-containing microarray of a biologically related substance through a reaction with a specimen labeled with such a fluorescent material associated with the same, the device being characterized in that it comprises
a light source for emitting light rays transmitting through the micro array;
a light source for emitting light rays used for the excitation of the fluorescent material present in a division;
an imaging means for imaging light rays which are emitted from the transmission light source and which are incident upon and transmit through the microarray and for imaging fluorescent rays emitted from the fluorescent material excited by the irradiation with the light from the source for excitation; and
a means for the detection of the position and/or size of a specific division arranged on the microarray on the basis of images of the light rays, which are converted into an image by the imaging means and transmit through the microarray.

2. The reading device as set forth in claim 1, wherein the portions of the microarray other than the division are so designed that they are opaque.

3. The reading device as set forth in claim 1, wherein it further comprises a means for moving the division arranged on the microarray into the visual field of the imaging means on the basis of the position of the division.

4. The reading device as set forth in claim 1, wherein the device is so designed that it selects a part of the image of the light transmitting through the microarray and imaged by the imaging means and detects the fluorescence emitted from the selected part.

5. The reading device as set forth in claim 1, wherein the detection means further comprises a correction means for correcting or compensating any difference between the optical systems used for imaging the transmitted light outputted from the microarray and for imaging the fluorescence emitted from the fluorescent material, respectively.

6. The reading device as set forth in claim 1, wherein the imaging means is a CCD camera.

7. The reading device as set forth in claim 1, wherein a single light source is used as both the transmission and excitation light sources.

8. The reading device as set forth in claim 1, wherein the transmission or excitation light source is so designed that it comprises a light-emitting means and an optical fiber bundle for guiding the light rays emitted from the light-emitting means.

9. The reading device as set forth in claim 1, wherein the transmission or excitation light source is an LED light source.

10. The reading device as set forth in claim 1, wherein the arrays in the microarray are arranged in a lattice so that the divisions thereof form a plurality of blocks.

11. The reading device as set forth in claim 1, wherein the device is so designed that it further comprises a means for moving the position at which the microarray is imaged and a means for indexing the position of a block arranged on the microarray and that the imaging means images the microarray for each block.

12. A method for reading a microarray of a biologically related substance comprising the steps of
preparing a multiple divisions-containing microarray of a biologically related substance, which is reacted with a specimen provided with a fluorescent material associated with the same;
irradiating the microarray with light rays and imaging the transmitted light which transmits through the microarray;
detecting the position and/or size of a division on the basis of the transmitted light which has been imaged in the transmitted light-imaging step;
irradiating the microarray with excitation light rays to thus excite the fluorescent material present in the division of the microarray and imaging the fluorescence emitted from the fluorescent material; and
reading the fluorescence imaged in the fluorescence-imaging step on the basis of the position and/or size of the division detected based on the transmitted light.

13. A method for reading a microarray of a biologically related substance comprising the steps of
preparing a multiple divisions-containing microarray of a biologically related substance, which is reacted with a specimen provided with a fluorescent material associated with the same;
irradiating the microarray with light rays and imaging the transmitted light which transmits through the microarray;
moving a division arranged on the microarray to an appropriate position within the visual field, to be imaged, of the imaging means on the basis of the transmitted light imaged in the transmitted light-imaging step;
again irradiating the microarray with light rays and imaging the transmitted light which transmits through the microarray;
detecting the position and/or size of the division;
irradiating the microarray with excitation light rays to thus excite the fluorescent material present in the division of the microarray and imaging the fluorescence emitted from the fluorescent material; and
reading the fluorescence imaged in the fluorescence-imaging step on the basis of the position and/or size of the division detected based on the transmitted light.

14. The microarray-reading method as set forth in claim 13, wherein it further comprises an additional step of masking the image obtained by imaging the fluorescence emitted from the fluorescent material, on the basis of the position and/or size of the division detected in the detection step.

15. The microarray-reading method as set forth in claim 13, wherein the arrays on the microarray are arranged in a lattice so that the divisions thereof form a plurality of blocks and, in the moving step, the microarray is moved in such a manner that the blocks are moved into the visual field to be imaged one at a time.

16. A microarray-reading method for reading the fluorescence emitted by a fluorescent material incorporated into a microarray through a reaction of a division of the microarray, on which a prove is immobilized, with a specimen provided with such a fluorescent material associated with the same, the method comprising the following steps:
a first step of preparing the microarray at a desired sample-supporting position;
a second step comprising irradiating the microarray with excitation light rays to thus excite the fluorescent material present in a division on the microarray and imaging the fluorescence emitted from the fluorescent material;
a third step of imaging the light obtained when irradiating with excitation light rays, while any microarray is not present at the sample-supporting position; and
a step of subtracting the image obtained in the third step as the background from the image obtained in the second step.

17. A microarray-reading method for reading the fluorescence emitted by a fluorescent material incorporated into a microarray through a reaction of a division on the microarray, on which a prove is immobilized, with a specimen provided with such a fluorescent material associated with the same, the method comprising the following steps:
a first step of preparing the microarray at a desired sample-supporting position;
a second step comprising irradiating the microarray with excitation light rays to thus excite the fluorescent material present in the division of the microarray and imaging the fluorescence emitted from the fluorescent material over several times;
a third step of imaging the light obtained when irradiating with excitation light rays, while any microarray is not present at the sample-supporting position; and
a step comprising subtracting the image obtained in the third step as the background from each of the plurality of images obtained in the second step and adding the plurality of images obtained in the subtraction step..

18. A microarray-reading method for reading the fluorescence emitted by a fluorescent material incorporated into a microarray through a reaction of a division of the microarray, on which a prove is immobilized, with a specimen provided with such a fluorescent material associated with the same, the method comprising the following steps:
a first step of preparing the microarray at a desired sample-supporting position;
a second step comprising irradiating the microarray with excitation light rays to thus excite the fluorescent material present in the division of the microarray and imaging the fluorescence emitted from the fluorescent material after the elapse of a plurality of different exposure times;
a third step of imaging the light obtained when irradiating with excitation light rays, while any microarray is not present at the sample-supporting position; and
a step comprising subtracting the image obtained in the third step as the background from each of the plurality of images obtained in the second step, normalizing the plurality of images obtained in the subtraction step with values proportional to 1/(exposure time) and extracting data from the resulting plurality of images.

19. A shading-correction method employed in the incident-light type excited fluorescence detection in which a sample is irradiated with excitation light rays and the fluorescence emitted from the same is detected and read from the light-reflecting direction, the method comprising the following steps:
a first step comprising irradiating with excitation light rays, while any sample is not present on a sample-setting position and storing the datum detected by a detector as the background datum for the device in itself;
a second step comprising irradiating with excitation light rays, while setting a reference reflecting plate having a predetermined reflectivity at the sample-setting position, subtracting the background datum for the device in itself from the datum detected by the detector and storing the datum obtained in the subtraction step as one for the shading-correction; and
a third step comprising irradiating with excitation light rays, while a sample is set at the sample-setting position, subtracting the background datum for the device in itself from the datum detected by the detector and carrying out desired shading-correction on the basis of the foregoing datum for the shading-correction.
